(19) United States
(12) Patent Application Publication
(10) Pub. No.: US 2023/0315014 A1
(43) Pub. Date: Oct. 5, 2023

(54) APPARATUS AND METHOD FOR COMPUTING HOLOGRAM DATA

(71) Applicant: SEEREAL TECHNOLOGIES S.A., Munsbach (LU)

(72) Inventors: Enrico ZSCHAU, Dresden Sachsen (DE); Johannes PLEIKIES, Dresden Sachsen (DE); Robert MISSBACH, Dresden Kreischa/OT Barenklause (DE)

(21) Appl. No.: 18/020,791

(22) PCT Filed: Aug. 6, 2021
(86) PCT No.: PCT/EP2021/072109

§ 371 Date: Feb. 10, 2023

(30) Foreign Application Priority Data
Aug. 10, 2020 (EP) 20190266.5

(51) Int. Cl. G03H 1/22; G03H 1/08

(52) U.S. Cl. CPC G03H 1/2294; G03H 1/0891; G03H 2226/05; G03H 2226/02

(57) ABSTRACT

The invention relates to a preprocessing circuit for at least one hologram computation circuit that comprises an input interface device for receiving data of a scene to be displayed, a processing device for defined processing of the received data and for converting the data into a system-independent format with incorporation of specific parameters required for displaying the scene, and an output interface device for outputting and transmitting the converted data to at least one hologram computation circuit. An apparatus for computing a hologram for displaying a scene by means of a holographic display apparatus is also disclosed. The apparatus comprises at least one spatial light modulation device and a preprocessing circuit as described, and at least one hologram computation circuit for computing a hologram and for encoding the hologram for the at least one spatial light modulation device.

The present invention relates to an apparatus having a hologram computation chip architecture, in particular a preprocessing circuit for at least one hologram computation circuit. Furthermore, the present invention also relates to an apparatus for computing holograms for displaying a preferably three-dimensional scene or an object. Moreover, the present invention also relates to a pipeline for real-time computation of holograms and a method for computing and encoding holograms as can be used, for example, for displaying three-dimensional scenes and objects using a holographic display apparatus or display.

The present invention thus discloses and describes a chip architecture and its various aspects for content preprocessing, for hologram computation, and for outputting the computed hologram on a three-dimensional light modulation device. One possible application of such a chip architecture can be holographic display apparatuses or displays for displaying preferably three-dimensional information, such as scenes or objects, where the application is not to be restricted to such display apparatuses, however.

A holographic display apparatus or display and a computation method for computing holographic data or holograms is described, for example, in WO 2004/044659 A2, WO 2006/066919 A1, WO 2008/138979 A1, or WO 2011/121130 A9, where the content of these documents is hereby also to be incorporated in its entirety. In particular the concepts of the hologram and subhologram and their meaning are described in detail in these documents, to which reference is made hereinafter. An overall hologram, also referred to solely as a hologram, is formed in this case by a defined number of subholograms, which mutually overlap to generate the hologram of the three-dimensional scene or object to be displayed.

In the prior art, for example, approaches are based on utilizing the symmetry, in particular a mirror symmetry, in the hologram or subhologram computation, i.e., hologram values only have to be calculated for one quadrant (i.e., in one-fourth) of a two-dimensional (2D) subhologram. The values of the remaining three quadrants are not computed explicitly, rather the computed values of the first quadrant of the 2D subhologram are used to determine the values of the three remaining quadrants, specifically in that the values of the computation result of the first quadrant of the 2D subhologram are generated or copied by corresponding mirroring of the values of the first quadrant along the main axes of the 2D subhologram. A mirror symmetry can be understood as at least one axial symmetry and/or one point symmetry, where the point symmetry can relate in particular to the center point of a subhologram.

However, the effort for computing subholograms using such a procedure is still extremely high. The applicant has therefore developed a method which minimizes this effort and furthermore advantageously utilizes the symmetry in order to compute the subhologram sufficiently. This method for computing a 2D subhologram, which is disclosed in US 2016/0132021 A1, will now be briefly described, wherein the content of US 2016/0132021 A1 is also to be incorporated in its entirety here.

An apparatus and a method for computing subholograms or an overall hologram are disclosed in US 2016/0132021 A1. A holographic display apparatus for displaying an object point of a three-dimensional scene has a spatial light modulation device having a matrix of pixels here. One pixel can also have multiple subpixels here. In this case, the pixel then corresponds to a macropixel. The 2D subhologram to be calculated contains complex values assignable to pixels of the spatial light modulation device, and has a rotational symmetry since it only depicts one object point of the three-dimensional scene. A complex value is to be understood in this context in particular as a complex number in the mathematical meaning. The apparatus for computing a 2D subhologram for displaying an object point of a three-dimensional scene is characterized in that the 2D subhologram contains a half 1D subhologram along a section through the 2D subhologram from the origin of the 2D subhologram to a maximum radius of the 2D subhologram, where the radius of each pixel is determined and each pixel of the 2D subhologram is permanently assigned at least one pixel of the half 1D subhologram having equal or similar radius by an electronic circuit. The maximum radius is the radius of the circle enclosing the 2D subhologram here. The amplitude values and phase values of pixels of the 2D subhologram which have the same distance to the origin of this 2D subhologram, thus all pixels of equal radius, are thus identical. The computation of one such pixel is therefore sufficient to also be able to use these values for other pixels of equal radius.

To effectively shorten the computation time and the computation effort for computing a hologram which is to be generated from the superposition of such 2D subholograms, pixels of equal or at least similar radius are assigned by an electronic circuit to a pixel of a half 1D subhologram, which, with the above-described location from the origin of the 2D subhologram up to a maximum radius, is part of the 2D subhologram, having the corresponding radius, and the calculation is only still carried out for this one pixel. Due to the permanent assignment by means of an electronic circuit, an additional step for ascertaining radii of other pixels, the additional addressing thereof, or adding lookup tables is therefore not necessary for this step. Such an electronic circuit is implementable as a digital circuit. However, analog circuits are also usable.

In one embodiment of the apparatus, each pixel of the 2D subhologram can be permanently assigned here to at least one pixel of the half 1D subhologram by an electronic circuit in such a manner that the radius of the pixel of the 2D subhologram corresponds to the radius of a pixel of the half 1D subhologram multiplied by a direction-dependent stretching factor.

The electronic circuit can be implemented for this purpose in the form of a hardwired matrix.

The electronic circuit is implemented here on field-programmable gate arrays (FPGAs), i.e., a programmable circuit, and/or application-specific integrated circuits (ASICs).

As mentioned, with a rotational symmetry of the 2D subhologram, the amplitude values and phase values of pixels of the 2D subhologram which have the same distance to the origin of this 2D subhologram, i.e., all pixels of equal radius, are identical. The arrangement of the pixels in the spatial light modulation device in matrix form, where the pixels have a defined size and a defined pitch, has the result, however, that for specific radii values of the pixels of the half 1D subhologram, amplitude and phase values are calculated, but an array of pixels are contained in the 2D subhologram of the object point, the radii values of which deviate from those of the half 1D subhologram. In the case of small deviations, the corresponding values calculated for the half 1D subhologram are nonetheless used for these. In the case of larger deviations of radii of pixels of the 2D subhologram from the radii of the specific pixels of the half 1D subhologram, however, it is advantageous to determine the required amplitude and phase values by using the values of two or more pixels of the half 1D subhologram having similar radii as those of the relevant 2D subhologram pixel. In principle, this can take place in linear form or also in nonlinear form, quadratic form or in general in exponential form. The latter is reasonable since the quantification error increases toward the edge of a 2D subhologram, i.e., toward larger radii.

The apparatus therefore has in its electronic circuit means for generating intermediate values by linking two or more pixels of the half 1D subhologram and for assigning the corresponding pixels of the 2D subhologram to these intermediate values.

To generate a hologram of the entire three-dimensional scene to be displayed, an apparatus for computing such a hologram of US 2016/0132021 A1 has the above-disclosed apparatus for computing a 2D subhologram of an object point of this three-dimensional scene. Moreover, this apparatus for computing such a hologram also has means for transforming the 2D subhologram generated using the apparatus for computing a 2D subhologram from polar to Cartesian coordinates, and moreover also from Cartesian into polar coordinates, means for positioning the 2D subhologram on the spatial light modulation device as a function of the location of the object point of the three-dimensional scene and the position of an observer of this scene and means for superimposing the respective 2D subholograms of various object points of the three-dimensional scene to be displayed by addition of the respective real and imaginary parts of the same pixels.

Furthermore, a pipeline for hardware-based real-time computation of holograms with the aid of subholograms is described in US 2016/0132021 A1. Such a pipeline is embodied in the form of a programmable circuit, in order to change or add new functional units later. The pipeline has means for computing subholograms and for directly activating a spatial light modulation device here. The pipeline is implemented on the basis of a field-programmable gate array (FPGA) and/or an application-specific integrated circuit (ASIC).

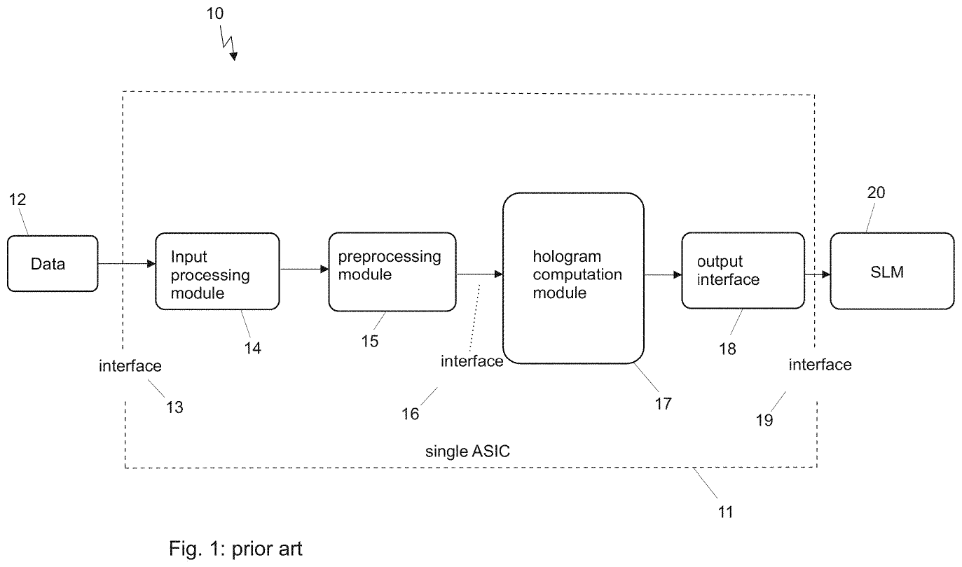

Such a pipeline contains functional units which are electronically interconnected with one another. FIG. 1 shows a block diagram of the structure of a typical hologram computation pipeline 10 having an ASIC (application-specific integrated circuit) 11, as can also be used, for example, in US 2016/0132021 A1. All functional units which are used or required for computing a hologram are provided in this case in the single ASIC 11. As can be seen from FIG. 1, data 12 of the information to be displayed, in particular data of object points of a scene, are supplied via an interface 13 to the ASIC 11, which receives and processes the data 12 of object points to describe a scene to be reconstructed via an input processing module 14. These data of the three-dimensional scene to be displayed are then processed in the ASIC 11 by means of a preprocessing module 15 and transmitted via a simple user-defined interface 16 to a hologram computation module 17 in the ASIC 11, which uses the data for hologram computation. The hologram computation module 17 is responsible in this case for the synthesis, the accumulation, and the encoding of the hologram. The computed hologram is then output via an output interface 18 and transmitted from the ASIC 11 via a simple interface 19 having a high bandwidth to a spatial light modulation device (SLM) 20 for display. These functional units are permanently integrated in the ASIC 11 or circuit. As is apparent in FIG. 1 due to the dashed line, the single ASIC 11 comprises the input processing module 14, the preprocessing module 15, the hologram computation module 17, and the output interface 18.

Viewed generally, the computation of holograms for encoding in a spatial light modulation device is very computing intensive, which has the result that very large and complex circuits, for example the ASIC according to FIG. 1, have to be developed and produced. Furthermore, a relatively large amount of waste heat arises during the computation by means of the circuit, which has to be dissipated. Due to the very high bandwidths of the data streams used, above all between the output interface of the ASIC and the spatial light modulation device, as shown in FIG. 1, data lines which are short in their length are rather to be preferred, since the power consumption for the transmission of the data has a significant proportion of the overall power consumption. However, there are more possibilities for reducing power consumption in the case of data lines which are short in their length. Spatial light modulation devices are in general electrically connected from multiple sides, i.e., left/right edge or upper/lower edge, to lines in order to transmit the data streams. As a result, the data line lengths become longer the larger the spatial light modulation devices become in their dimensions. A single circuit, for example in the form of an ASIC according to FIG. 1, however, also means that this is especially developed for a single spatial light modulation device and can usually only be used with difficulty for other spatial light modulation devices or holographic display apparatuses, above all if the required computing power of holograms significantly differs or the bandwidths at the interfaces strongly vary.

It is therefore the object of the present invention to refine an apparatus and a method for computing a hologram of the type mentioned at the outset in order to overcome or eliminate the disadvantages of the prior art. In particular, the power consumption or the energy costs are to be reduced and kept low in comparison to apparatuses and methods of the prior art. Moreover, the production of such apparatuses is to be simplified and the costs are to be reduced.

The display of a two-dimensional and/or three-dimensional scene is also to be understood here in the sense of reconstruction of a two-dimensional and/or three-dimensional scene.

The present object is achieved according to the invention by a preprocessing circuit having the features according to claim 1.

According to the invention, a preprocessing circuit for at least one hologram computation circuit is provided. The preprocessing circuit has an input interface device for receiving data of a scene to be displayed, preferably a three-dimensional scene, a processing device for defined processing of the received data and for converting the data into a system-independent format with incorporation of specific parameters required for displaying the scene, and an output interface device for outputting and transmitting the converted data to at least one hologram computation circuit.

To bypass and avoid the above-mentioned disadvantages and problems, it is provided according to the invention that the individual functions of a circuit known from the prior art for computing holograms are divided into multiple separate circuits or devices. This means that according to the invention at least two circuits are used or employed to compute holograms, which replace the single circuit according to the prior art, or the single known circuit for computing holograms according to the prior art is divided into at least two circuits. A preprocessing circuit is now provided according to the invention, which processes or preprocesses data of a hologram to be computed before these data are transmitted for direct computation of a hologram to at least one hologram computation circuit and used therein. Functionality is now implemented in the preprocessing circuit which is only required once in the overall computation system made up of preprocessing circuit and hologram computation circuit, however, namely upon the preprocessing of the data of the scene. This functionality is therefore only implemented once. An implementation of this functionality in the direct computation of the hologram in the hologram computation circuit is not provided in principle, so that advantageously the preprocessing of data is separated from the direct computation of the data of a hologram and can be housed in at least two circuits separate or isolated from one another. In this way, a preprocessing circuit and at least one hologram computation circuit are now provided according to the invention, where both circuits are designed as independent or separate circuits and are operated separately from one another.

The preprocessing circuit according to the invention therefore only comprises devices or modules which preprocess incoming or transmitted data for a hologram. A direct computation of a hologram does not take place by means of the preprocessing circuit. To implement preprocessing of data, the preprocessing circuit comprises an input interface device, a processing device, and an output interface device. The input interface device is used to receive data of a preferably three-dimensional scene to be displayed. The processing device is provided for defined processing of the received data and for converting the data into a system-independent format with incorporation of specific parameters required for displaying the preferably three-dimensional scene. The processing device thus processes the data according to a defined requirement and subsequently converts the preprocessed data of a scene to be displayed into a generalized format processable for at least one spatial light modulation device. This means that the preprocessed data are not tailored to a special spatial light modulation device. The conversion into a system-independent format takes place here with application of defined specific parameters of a spatial light modulation device. These parameters can be, for example, items of information on wavelengths to be used, on the screening of the spatial light modulation device used, on the required or existing resolutions, on distances, for example between an observer and the spatial light modulation device, on correction tables and correction parameters in order to execute specific corrections, for example, of distortions or wavelength-dependent aberrations, items of interface information, interface configurations, or also general interface parameters.

The output interface device, in contrast, is provided for outputting and distributing the converted data to at least one hologram computation circuit. These data preprocessed in the preprocessing circuit are therefore then transmitted to at least one hologram computation circuit, which thereupon uses these data to compute a hologram.

Due to the design having at least two separate circuits, it is advantageously possible to use not only one hologram computation circuit, which is possible in principle, however, but also multiple, i.e., at least two hologram computation circuits, which are only used to directly compute a hologram, the arrangements of which in relation to a spatial light modulation device, for which the computed hologram is then encoded, can take place in a more optimized manner, which will be discussed in detail hereinafter.

Due to the outsourcing and implementation of functionality—which is only required once during the preprocessing of data—in the preprocessing circuit, the size (dimensions) and the costs for producing the hologram computation circuit can be significantly reduced and lowered. Since the preprocessing circuit primarily carries out simple image processing and requires little computing power in comparison to the hologram computation circuit, the power consumption of the preprocessing circuit is low, and is thus less relevant. A larger and more cost-effective structural width (so-called technology node) can therefore advantageously also be used here, due to which the development costs and production costs can be reduced. The preprocessing circuit can be designed to be reusable. Since the development and the production of such a preprocessing circuit are significantly less expensive than the development and production of a hologram computation circuit, however, revisions or checks of various products of spatial light modulation devices are conceivable and possible, also to enable various new interfaces and formats on the input side of the preprocessing circuit and new functions.

The preprocessing circuit is implemented as an independent or separate circuit. It operates independently of a hologram computation circuit. This enables the power consumption and the production costs as a whole to be reduced, since the preprocessing circuit as an independent circuit only carries out functions which only have to be carried out once in the computation process, so that at least one following, also independent or separate hologram computation circuit only carries out the computation of a hologram on the basis of the data transmitted by the preprocessing circuit. In this way, the power consumption which the hologram computation circuit requires for the computation can be kept low.

Further advantageous embodiments and refinements of the invention result from the further dependent claims.

The preprocessing circuit can advantageously be implemented as a field-programmable gate array (FPGA) or as an application-specific integrated circuit (ASIC). Implementation as an FPGA (field-programmable gate array) can be more cost-effective depending on the production piece count.

The preprocessing circuit receives the data of the preferably three-dimensional scene to be computed and displayed, parameters, and programs via the input interface device, a so-called standardized interface. The input interface device can be designed here, for example, as a DisplayPort, HDMI (High Definition Multimedia Interface), as one or more network interfaces, or also as any other interface having the required bandwidth.

It can advantageously be provided here that the data, parameters, and programs supplied to the preprocessing circuit are provided in an encrypted format.

The data of the preferably three-dimensional scene can be supplied or provided in various formats, e.g., as a three-dimensional point cloud, as a three-dimensional volume, or as a compilation of scanned images or two-dimensional matrices of one or more views from one or more planes, i.e., images made up of color and depth features, possibly in multiple planes to implement transparency or volume in holograms. Arbitrary other formats are possible. The resolution of the data is flexible, where the implemented product of a spatial light modulation device possibly implements a specific maximum resolution for the playback of the contents, however. The possibility of receiving and processing conventional two-dimensional data, which are prepared or evaluated by the preprocessing for the holographic display, represents a special feature.

The preprocessing circuit can carry out various preprocessing actions. The processing device which has the preprocessing circuit carries out these preprocessing actions. It can be designed so as to perform, for example, a color correction, a brightness correction, and/or a position correction separately for each wavelength (color) and each view of the resulting displayed object points of the preferably three-dimensional scene. Viewed generally, it can therefore be provided that the processing device is designed for correcting aberrations in the display of the scene. However, the processing device can also be designed for evaluating, improving, adapting, and/or in general for changing the received data.

These data preprocessing actions by means of the processing device in the preprocessing circuit can also be used, for example, for correcting various effects of an optical system, provided in an employed holographic display apparatus. According to the invention, it can therefore be provided that the processing device is designed for correcting aberrations or of effects having a negative effect on a scene to be displayed of an optical system provided in a holographic display apparatus.

Different corrections for each wavelength (color) used of the light for displaying the preferably three-dimensional scene can also be carried out by means of the preprocessing circuit or the processing device of the preprocessing circuit, in order to compensate wavelength-dependent effects in the optical system of an employed holographic display apparatus differently if necessary.

In a further embodiment of the invention, the processing device can be designed for the defined correction of visual defects of at least one eye of an observer of the scene to be displayed. A limited subsequent correction of visual defects of one or both eyes of an observer who observes the displayed scene can also be performed using the processing device of the preprocessing circuit. For this purpose, the processing device can process the data of the hologram to be computed in such a way that the object points of the scene to be displayed by means of the hologram are individually shifted, rotated, and/or distorted in each dimension/direction.

In one particularly advantageous embodiment of the invention, it can be provided that the processing device is designed in such a way that upon use of eye tracking data in conjunction with foveated rendering, the resolution, the degree of detail, and/or the holographic quality of the scene to be displayed is adaptable on the basis of a viewing direction of an eye of an observer in defined areas of a field of view of the observer.

Using eye tracking data for tracking eyes of an observer in real time, so-called foveated rendering can be implemented, in that the resolution, the degree of detail, and/or the holographic quality of the preferably three-dimensional scene can be adapted on the basis of the present or predicted viewing direction of an eye of an observer. The resolution, the degree of detail, and/or the holographic quality of the scene can be adapted by means of the preprocessing device by processing the received data here so that upon observation of the three-dimensional scene in the edge area of the fovea of the eye of the observer, the resolution, the degree of detail, and/or the holographic quality of the scene is provided in reduced form. In the viewing direction of the eye of the observer, in contrast, the displayed scene has a high resolution, a high degree of detail, and/or a high holographic quality, whereas in the edge area of the scene which is not looked or aimed at directly by the observer, the resolution, the degree of detail, and/or the holographic quality are reduced. The number of the wavelengths (colors) of the light can also be reduced. This means that the data of the scene can be processed by means of the processing device in such a way that the resolution, the degree of detail, and/or the holographic quality of the scene is reduced in its edge area. Using such preprocessed data, the required hologram can then be computed after transmitting these data to at least one hologram computation circuit. In this way, the power consumption for computing the hologram for the preferably three-dimensional scene to be displayed can be reduced or lowered in the at least one hologram computation circuit. Such a processing can also be used to define which wavelengths of the light used have to be displayed in the peripheral field of view of the observer in order to save additional energy in the at least one hologram computation circuit.

Advantageously, it can furthermore be provided that the processing device is designed to control controllable components of at least one spatial light modulation device or a holographic display apparatus.

The processing device can furthermore assume the overall control of at least one spatial light modulation device or a holographic display apparatus. This means that the processing device or, viewed in general, the preprocessing circuit can activate or control in a defined manner all electronic or controllable components of at least one spatial light modulation device or a holographic display apparatus. Such controllable components or systems can be, for example, an illumination device comprising at least one light source, for example a laser or LED, or devices for shifting or tracking a virtual visibility area/observer window. A control of active optical elements for modulating and manipulating incident light waves in the at least one spatial light modulation device with the goal of synchronous and efficient operation and interaction is also possible by means of the processing device or the preprocessing circuit.

In a further advantageous embodiment of the invention, a combination made up of a permanent logic having paths switchable at the run time or paths switchable once at the run time and at least one processor can be used in the processing device of the preprocessing circuit. The preprocessing circuit uses in its processing device a combination made up of permanent logic having paths switchable at the run time or paths switchable once and at least one embedded processor having at least one processor core, where advantageously multiple processors or processor cores can be used, on which the required programs and modules run (the number thereof is dependent on the tasks, the amount of the data to be computed, and the number of parallel computation paths), in order to perform all required tasks. An embodiment of the processing device even without programs or processors or processor cores is also conceivable and implementable.

A further function of the preprocessing circuit is the implementation of a timing controller for direct clocking and control of at least one spatial light modulation device, for which the computed hologram is encoded, and of source drivers or general components and circuits, in order to drive at least one spatial light modulation device and transfer the computed data of a hologram into the pixels or pixel cells of the at least one spatial light modulation device. For the case that multiple, i.e., at least two hologram computation circuits, which follow the preprocessing circuit and are also designed to be independent, are provided, these are synchronized in accordance with the above-mentioned control of the at least one spatial light modulation device for smooth operation by means of the preprocessing circuit. In other words, a timing controller can be provided for generating control signals and/or synchronization signals in the preprocessing circuit.

It is furthermore known from the prior art that buffering of a hologram is generally necessary in order to perform a normalization of complex-value data in the context of an encoding step (encoding), in order to enable the display of the data on pixels having limited resolution of at least one spatial light modulation device. For example, the bit number is defined at 8 bits per (sub-)pixel, for example, where an arbitrary value is present depending on the application, however.

A normalization of a hologram can be understood as the simplest method, for example, as the ascertainment of the maximum absolute value of all complex numbers in the hologram, i.e., a maximum magnitude or amplitude. This magnitude is then used for scaling all values in the hologram to the available value range (corresponding to the bit number). However, other normalization methods are also possible, for example, a normalization of holograms based on histograms.

A typical normalization of holograms according to the prior art requires the complete data set, so that the complete hologram can be executed in full value resolution, in general by floating-point or discrete values having very high bit resolution, for example 16 bit, in order to determine the normalization parameters before the normalization can be executed on discrete values, i.e., the bit number of the spatial light modulation device used. Therefore, the hologram either has to be buffered in an external memory or in the circuit used for computation, for example in the ASIC itself. An ASIC having correspondingly large storage capacity would however be very large in its dimensions (chip size) and very expensive to produce. The use of an external memory, in contrast, means a higher power consumption and complexity by orders of magnitude. Suitable external memories are very costly with respect to costs and power consumption, because of the high number of additional high-speed data lines, the costly high-performance memory circuits, and for the corresponding usage license. All of these factors make such a circuit or ASIC unprofitable or inefficient and a competitive product of a spatial light modulation device nearly impossible. Both possibilities therefore do not offer profitable solutions.

Therefore, in one particularly advantageous embodiment of the invention, it can be provided that the processing device is designed to carry out analyses of data of the scene to be displayed, in order to implement or execute a normalization of a hologram or a hologram normalization.

To implement a normalization of a hologram or a hologram normalization in the last step in the hologram computation, the encoding, the processing device of the preprocessing circuit carries out, according to the invention, special analyses of the data of the preferably three-dimensional scene to be displayed, in order to enable an approximately correct hologram normalization. In this way, buffering of the complete hologram can be avoided, so that a following hologram computation circuit does not require a buffer memory. An absolutely exact normalization of the hologram data is not required in principle, since a small deviation in general would only result in a barely perceptible variation in the brightness of the hologram or the preferably three-dimensional scene displayed. The avoidance of a buffer memory in the hologram computation circuit thus reduces the complexity and the power consumption of the hologram computation circuit significantly or by orders of magnitude.

It can moreover advantageously be provided that the preprocessing circuit is characterized by a scalability for various variables of the at least one spatial light modulation device and/or hologram resolutions and/or scene resolutions and/or parameters of the at least one spatial light modulation device by a variable activation of computation paths.

Furthermore, the present object is also achieved according to the invention by an apparatus having the features according to claim 13.

According to the invention, an apparatus is proposed for computing a hologram for displaying a scene by means of a holographic display apparatus, which comprises at least one spatial light modulation device. The apparatus according to the invention for computing a hologram comprises an above-described preprocessing circuit according to the invention and at least one hologram computation circuit for computing a hologram and for encoding the hologram for the at least one spatial light modulation device.

The apparatus therefore comprises the preprocessing circuit according to the invention, which was explained in detail above, and at least one, preferably at least two hologram computation circuits, so that the individual functions which are required for computing a hologram are divided onto multiple devices, i.e., multiple independent or separate circuits. The at least one hologram computation circuit can therefore be implemented as an independent circuit or the at least one hologram computation circuit can be implemented independently of the preprocessing circuit.

The implementation of the described architecture according to the invention solves the following technical hurdles in comparison to the 1-chip approach or a single circuit of the prior art. The preprocessing circuit and also the at least one hologram computation circuit can be reused as components for various products of a spatial light modulation device. Circuits implemented in the form of ASICs are generally costly to develop, but can be accordingly inexpensive to produce when mass-produced. The reusability of such circuits according to the invention therefore increases the piece counts and thus reduces the production costs. Moreover, the design of the hologram computation circuit according to the invention can advantageously be marketed with the aid of the supplied preprocessing circuit according to the invention. This fact in turn also permits producer-specific adaptations to interfaces of a spatial light modulation device and the selection of suitable independent manufacturing technologies. Due to the provision of at least two circuits, namely the preprocessing circuit and at least one hologram computation circuit, each individual circuit can be optimized in its chip size. This means that each chip or each circuit only implements the functions which are necessary so that larger dead (unoccupied) or switched-off areas are not provided. An important and decisive advantage results therefrom in relation to circuits in the form of a 1-chip according to the prior art as according to FIG. 1, for example, namely the optimization of power consumption and heat generation in operation of a spatial light modulation device and thus of a holographic display apparatus, and space requirement or integration density and production costs due to provided scalability, since the hologram computation circuit can be used for different variants of a spatial light modulation device. In other words, the at least one hologram computation circuit can be provided for different embodiments or designs of the at least one spatial light modulation device.

Like the preprocessing circuit, the at least one hologram computation circuit can also be implemented as a field-programmable gate array (FPGA) or as an application-specific integrated circuit (ASIC).

The at least one hologram computation circuit can according to the invention comprise an input interface device for receiving data processed by the preprocessing circuit, a hologram computation device for computing and encoding the hologram, and an output interface device for transmitting the data of the computed hologram to the at least one spatial light modulation device.

The input interface device of the at least one hologram computation circuit thus receives the data processed or preprocessed in the preprocessing circuit in a system-independent format or in a generalized format processable by the hologram computation circuit. In other words, a supply of data of the scene processed by the preprocessing circuit is provided in a system-independent format to the at least one hologram computation circuit. For this purpose, the at least one hologram computation circuit can advantageously be designed in such a way that the data of the scene supplied in a system-independent format are directly usable and the hologram is computable. However, the special case can also be possible that the incoming data of the scene are not provided in a system-independent format and therefore also still have to be preprocessed in the at least one hologram computation circuit. However, complex preprocessing like that implemented by the preprocessing circuit then does not take place.

The hologram computation device of the at least one hologram computation circuit then computes a hologram from these transferred data and is used for encoding the hologram for a spatial light modulation device. Moreover, the at least one hologram computation circuit also has an output interface device which transfers the data of the computed hologram to the spatial light modulation device.

The at least one hologram computation circuit can be designed in a highly integrated manner as part of the at least one spatial light modulation device. For this purpose, it can be provided or arranged in the vicinity of so-called source drivers. Current developments are also laying the foundation that such a hologram computation circuit and a preprocessing circuit according to the invention can be applied directly to a substrate of the at least one spatial light modulation device (chip on glass). In other words, the at least one hologram computation circuit can be designed as part of the at least one spatial light modulation device or can be implemented directly on a substrate of the at least one spatial light modulation device.

It can preferably moreover be provided that at least two hologram computation circuits are provided, which are connected in series and/or in parallel to one another.

It is particularly advantageous if multiple hologram computation circuits are provided, for example implemented as an ASIC. These at least two hologram computation circuits can be arranged, for example, close to the connections or source drivers of a spatial light modulation device. For this purpose, the hologram computation circuits can be connected in series to one another and can be arranged in the area of the lateral surface of the spatial light modulation device. It is also possible to connect and arrange the hologram computation circuits in parallel to one another. Furthermore, a combination made up of series circuit and parallel circuit of the hologram computation circuits could also be advantageous, in particular if a large number of hologram computation circuits is provided. The division into multiple hologram computation circuits additionally also has a significant advantage, which is to be found in the uniform dissipation of the waste heat via multiple small spots (hotspots) instead of via one large spot as in circuits in the prior art. The number of hologram computation circuits to be used results from the required computing power and the required bandwidth to the spatial light modulation device. Both of these generally also scale with the size of the spatial light modulation device, which means that the larger the area of the spatial light modulation device is, the larger the number of hologram computation circuits is supposed to be. The proximity of the hologram computation circuits to the edge of the spatial light modulation device or the source drivers of the spatial light modulation device enables short data lines, which correspondingly advantageously reduces the power consumption at the very high data rates.

The interface or the output interface device of the or each hologram computation circuit to the spatial light modulation device can be designed flexibly here and can thus enable an adaptation of the data rate, the number of the transmission lines, and the protocol to be used. For this purpose, the corresponding data paths can be permanently activated or configured on the hologram computation circuit in the production of a spatial light modulation device. This can take place, on the one hand, at the run time during the initialization of the hologram computation circuit or also can be permanently set via configuration bridges (antifuses) in the hologram computation circuit.

An external data interface device can advantageously be provided for the encrypted supply of data and programs to the preprocessing circuit. This external data interface device can be provided for the purpose of supplying the data which the preprocessing circuit uses and programs which are executed on the preprocessing circuit in encrypted form to the preprocessing circuit.

For this purpose, the encrypted data and programs supplied to the preprocessing circuit can be stored in encrypted form on a nonvolatile memory. The nonvolatile memory can be provided in this case externally or internally, i.e., outside or inside the preprocessing circuit. A harmful access can be avoided in this way.

It can particularly advantageously be provided according to the invention that a mutual authentication or authenticity check is implemented between the preprocessing circuit and the at least one hologram computation circuit. This is a measure in terms of an authenticity check to prevent unauthorized copies of either the preprocessing circuit or the at least one hologram computation circuit.

This has the advantage that marketing of the apparatus according to the invention made up of preprocessing circuit and at least one hologram computation circuit or also the independent or separate circuits, preprocessing circuit and hologram computation circuit is possible in each case as an independent product. For this purpose, the design of the circuit, i.e., the “source code” or the RTL design, can be made available as an encrypted IP core. This IP core can thus only be read and processed by EDA tools (electronic design automation) for FPGA or ASIC design.

The preprocessing circuit executes special tasks, in which a large amount of know-how with respect to calibrating the spatial light modulation device, correcting the hologram, and adapting/utilizing the preferably three-dimensional scene is concealed and implemented. At least one preprocessing circuit for activating the at least one hologram computation circuit is required per product of a spatial light modulation device or holographic display apparatus. By way of measures such as protected non-externally readable data areas (EEPROMs, externally writable, only internally readable) in the preprocessing circuit, an encryption technology can be used to implement a mutual authentication for the purpose of an authenticity check between the preprocessing circuit and the at least one hologram computation circuit and to encrypt transmission channels. Private keys can be stored in the protected area of the preprocessing circuit on the basis of common or previously known encryption methods, for example, TLS or SSL, which are required for decrypting the parameters of the spatial light modulation device and programs on the external or internal nonvolatile memory. The preprocessing circuit and the at least one hologram computation circuit can thus also mutually authenticate one another, in order to in each case check and prove their authenticity. If this check fails, the respective circuit, preprocessing circuit and/or hologram computation circuit can be put into a special invalid mode, for example. The effects thereof can be manifold, e.g., overlaying a corresponding item of information on the spatial light modulation device or holographic display apparatus, stopping the operation of the holographic display apparatus, operating in a significantly reduced quality of the preferably three-dimensional scene displayed, or similar measures.

Furthermore, the apparatus according to the invention can particularly advantageously be characterized by a scalability of the preprocessing circuit and/or the at least one hologram computation circuit for different variables of the at least one spatial light modulation device and/or hologram resolutions and/or scene resolutions and/or parameters of the at least one spatial light modulation device by a variable activation of computation paths.

A hologram computation circuit can thus be employed or used in multiple ways in conjunction with a spatial light modulation device. If specific requirements, for example, with respect to the aspect ratio of at least similar pixel pitch are met, the same hologram computation circuit can also be used in various products of a spatial light modulation device, since thus a costly development and production of a circuit for computing holograms per product of a spatial light modulation device can be avoided. Circuits designed smaller in their shape, for example ASICs, in comparison to one circuit larger in the dimensions, for example ASIC, additionally has the advantage that a higher yield can be achieved in the production. The development and verification are moreover also less complex. The current consumption can also be reduced by the use of smaller process structures. This is worthwhile if high piece counts of hologram computation circuits are to be provided, which is assisted by the generalization and division into multiple or into at least two hologram computation circuits. In principle, the provision of at least two hologram computation circuits also enables marketing of the design of the hologram computation circuit.

The present object is furthermore achieved according to the invention by a holographic display apparatus having the features according to claim 25.

The holographic display apparatus according to the invention comprises the following features:
an above-described preprocessing circuit according to the invention,
at least one above-described hologram computation circuit according to the invention for computing a hologram, and
at least one spatial light modulation device, for which the computed hologram is encoded.

Such a holographic display apparatus according to the invention has a significantly lower power consumption, a lower heat generation in operation of the display apparatus, lower production costs, and optimized circuits for computing holograms in comparison to a holographic display apparatus of the prior art. Moreover, the advantages described with respect to the individual components of the display apparatus, in particular with respect to the preprocessing circuit and the hologram computation circuit, also apply here.

The data of the hologram computed using the at least one hologram computation circuit can be transmitted via at least one source driver to the at least one spatial light modulation device. In other words, at least one source driver can be provided, using which data of the hologram computed using the at least one hologram computation circuit are transmittable to the at least one spatial light modulation device.

The holographic display apparatus according to the invention can moreover comprise at least one illumination device, which comprises at least one light source, and an optical system, by means of which a scene is reconstructable in conjunction with the at least one spatial light modulation device.

Moreover, the present object of the invention is also achieved by a pipeline for real-time computation of holograms having the features according to claim 28.

The pipeline according to the invention for real-time computation of holograms comprises an above-described preprocessing circuit according to the invention for preprocessing data of a scene and for directly activating components of at least one spatial light modulation device and at least one above-described hologram computation circuit according to the invention for computing holograms, where the preprocessing circuit and the at least one hologram computation circuit are each implemented on the basis of a field-programmable gate array (FPGA) and/or an application-specific integrated circuit (ASIC).

The computation and output of holograms for display on a spatial light modulation device, in particular on the basis of the described apparatuses and methods still to be described hereinafter, using circuits, is described hereinafter in the form of a pipeline for hardware-based real-time computation of holograms with the aid of subholograms and direct activation of at least one spatial light modulation device. Such a pipeline according to the invention is distinguished in that it comprises a preprocessing circuit and at least one hologram computation circuit, which both form independent or separate circuits.

The pipeline according to the invention for real-time computation of holograms thus comprises the preprocessing circuit for preprocessing data of a preferably three-dimensional scene and for directly activating at least one spatial light modulation device and the at least one hologram computation circuit for computing holograms. It is moreover characterized in that the preprocessing circuit and the at least one hologram computation circuit are implemented on the basis of a field-programmable gate array (FPGA) and/or an application-specific integrated circuit (ASIC).

In particular, such a pipeline can comprise an apparatus according to the invention for computing a hologram, in particular a subhologram, for displaying a preferably three-dimensional scene or a scene constructed from object points.

It can be particularly advantageous if the preprocessing circuit and the at least one hologram computation circuit are configurable at the run time.

The preprocessing circuit and at least one hologram computation circuit implemented as a field-programmable gate array (FPGA) and/or as an application-specific integrated circuit (ASIC) can be subsequently configurable, i.e., can also still be configurable during the run time.

The preprocessing circuit and the at least one hologram computation circuit of the pipeline according to the invention are electronically interconnected with one another, where the preprocessing circuit implements the following fundamental functions:
receiving data, for example object points, to describe a scene to be reconstructed and displayed via an input interface device,
preprocessing the received data of the scene to be displayed, in particular defined processing and converting of the data into a system-independent format with incorporation of specific parameters required for displaying the scene, by means of a processing device, and
outputting and transmitting the preprocessed and converted data to at least one hologram computation circuit via an output interface device,

where the hologram computation circuit implements the following fundamental functions:
receiving data preprocessed by the preprocessing circuit via an input interface device,
computing and encoding the hologram by means of a hologram computation device, and
transmitting the data of the computed hologram to the at least one spatial light modulation device via an output interface device.

The preprocessing circuit and the at least one hologram computation circuit are integrated in an overall circuit, but are configurable at the run time, i.e., they are not assigned to a specific spatial light modulation device. In other words, the preprocessing circuit and the hologram computation circuit are not intended for a specific type of spatial light modulation device or developed for a defined type, but rather can be adapted by corresponding configuration upon start-up to their environment (type of the spatial light modulation device, etc.). If necessary, they can be reconfigurable subsequently. This enables such a pipeline to be designed so that both one-dimensional and also two-dimensional holograms can be computed and output in real time, and various encoding types and output modes can be supported.

Expressed generally, the preprocessing circuit and the at least one hologram computation circuit are independent or separate circuits, which are connected to one another in such a way that the at least one hologram computation circuit is activatable by means of the preprocessing circuit, but the preprocessing circuit and the at least one hologram computation circuit are not assigned to a specific spatial light modulation device and/or holographic display apparatus.

Furthermore, a high computing power at low clock frequency can be ensured by the pipeline according to the invention by means of high parallelism in the processing of the data. This is important in particular with regard to a minimal power consumption.

The scalability of the pipeline for various dimensions of the at least one spatial light modulation device and/or hologram resolutions and/or scene resolutions and/or parameters of the at least one spatial light modulation device by a variable activation of the calculation path is also to be viewed as an advantage. The pipeline accordingly contains computation paths which are deactivatable and also activatable again.

A further important aspect in combination with a generalized implementation according to the invention of the hologram computation is thus the scalability. A hologram computation circuit can thus be used or employed multiple times in conjunction with at least one spatial light modulation device. If certain conditions are met, for example with respect to the aspect ratio of at least similar pixel pitch, the same hologram computation circuit can also be used in various products of a spatial light modulation device. The enormous cost factor for producing a previously known circuit in the form of an ASIC could be decisive for this purpose. If the same type of circuit can thus be used multiple times in one product or in various products, the costly development and production of a circuit for calculating holograms per product of a spatial light modulation device can be avoided. Circuits formed small in their shape, for example ASICs, in comparison to a circuit which is large in the dimensions, for example an ASIC, additionally have the advantage that a higher yield can be achieved in the production. The development and verification are moreover also less complex.

To lower the cost of the power consumption and the piece count with respect to a hologram computation circuit according to the invention, smaller process structures can be sought. This is worthwhile above all if high piece counts of hologram computation circuits are also planned, which is assisted by the generalization and division into multiple or into at least two hologram computation circuits.

In principle, the provision of at least one hologram computation circuit also enables marketing of the design of the hologram computation circuit. This enables, for example, a producer of a spatial light modulation device to adapt to their own processes and interfaces and to use production methods which are their own or are suitable for them.

In particular, the function of the hologram computation circuit is to be viewed in conjunction with US 2016/0132021 A1 and the method for hologram normalization set forth hereinafter, the content of which is hereby to be incorporated in its entirety and the disclosed methods of which for computing a hologram, as briefly described at the outset of this document, can be carried out by means of the hologram computation circuit according to the invention.

Furthermore, the present object of the invention is also achieved by a method for computing a hologram having the features according to claim 34.

The method according to the invention is provided for computing a hologram to display a scene by means of a holographic display apparatus, which comprises at least one spatial light modulation device, where the computation of the hologram is carried out by means of a preprocessing circuit and at least one hologram computation circuit.

The method according to the invention uses two (or more) independent or separate circuits, a preprocessing circuit, and at least one hologram computation circuit to compute a hologram of a preferably three-dimensional scene to be displayed.

It can advantageously be provided here that the preprocessing circuit processes data, which are only required once in the preprocessing for computing the hologram, and the at least one hologram computation circuit computes the hologram provided for encoding for the at least one spatial light modulation device from the data provided by the preprocessing circuit and outputs it to the at least one spatial light modulation device.

Functionality which is only used or required once in the preprocessing for computing a hologram is therefore only implemented once. This functionality is therefore implemented in the separate preprocessing circuit. The preprocessing circuit primarily only carries out simple image processing, for example, changing and improving the data, adapting the data to an optical system of a holographic display apparatus, correcting aberrations, etc., as already described above and therefore requires a low computing power in comparison to the computing power of the at least one hologram computation circuit, which performs the actual computation of a required hologram.

In one embodiment of the invention, an input interface device of the preprocessing circuit can receive data of a scene to be displayed in an encrypted format, for example in the context of rights management, decrypt these data, and transmit them to a preprocessing device of the preprocessing circuit.

The preprocessing circuit thus receives the data of a preferably three-dimensional scene to be displayed, for example, data of object points of a scene, via an input interface device and decrypts these encrypted data. The input interface device can be a standardized interface, e.g., a DisplayPort, HDMI, one or more network interfaces, or any other interface having the required bandwidth. The data of the scene can be supplied in various formats, e.g., as a three-dimensional point cloud, as a three-dimensional volume, or as a compilation of scanned images or two-dimensional (2D) matrices of one or more views from one or more planes, i.e., images made up of color and depth features, possibly in multiple planes, to implement transparency or volume in holograms are possible. Any other formats are also possible, in particular also classic two-dimensional formats or stereo formats, which can then be converted accordingly by the preprocessing circuit into a three-dimensional format. The resolution of the data of the scene is flexible, where the implemented product of a spatial light modulation device or a holographic display apparatus possibly also implements a specific maximum resolution for reproduction of the contents of the preferably three-dimensional scene, however.

The transmitted data can then be preprocessed according to the invention in accordance with the scene to be displayed by means of the preprocessing device of the preprocessing circuit and the preprocessed data can be converted in consideration of specific parameters of the at least one spatial light modulation device into a system-independent format.

The preprocessing device preprocesses the transmitted data in accordance with defined parameters and specifications and subsequently converts these preprocessed data of the scene to be displayed to compute a hologram into a generalized format, processable by the at least one following hologram computation circuit, with application of specific parameters of the at least one spatial light modulation device. These specific parameters can be, for example, inter alia, items of information on wavelengths, on scanning of a spatial light modulation device, on resolutions of the scene or hologram, on distances, for example between an observer and the spatial light modulation device, correction tables and correction parameters, in order to carry out certain corrections, for example, of distortions or wavelength-dependent aberrations, items of interface information, interface configurations, and interface parameters.

The preprocessing device of the preprocessing circuit can carry out various preprocessing actions. These can include, for example, a color correction and a position correction of the resulting displayed object points of the scene. The preprocessing actions in the data can also be carried out, for example, in order to correct various effects of an optical system provided in a holographic display apparatus. Different corrections for each wavelength (color) can also be carried out in the data by means of the preprocessing device, in order to compensate differently for wavelength-dependent effects in the optical system, if necessary. Therefore, viewed generally, aberrations of the scene to be displayed can be corrected by the preprocessing device, by which data corrected for aberrations are generated.

Furthermore, it can also be provided that visual defects of an eye of an observer of the scene to be displayed can be corrected by means of the preprocessing device by virtual shifting, rotation, and/or distortion of the scene.

It is also possible to perform a subsequent correction of ocular visual defects of an observer of the displayed scene in the preprocessing circuit by means of the preprocessing device. For this purpose, data are processed in the preprocessing device in such a way that the object points of the scene are individually shifted, rotated, and/or distorted in each dimension.

It can be particularly advantageous if the resolution, the degree of detail, and/or the holographic quality of the scene to be displayed is adapted in consideration of a viewing direction of an eye of the observer by the preprocessing device in such a way that the displayed scene is computed in its edge area having a reduced resolution, a reduced degree of detail, and/or a reduced holographic quality by a hologram computation device of the at least one hologram computation circuit.

This procedure is particularly advantageous if so-called foveated rendering is implemented with application of eye tracking data, i.e., in the case of tracking of the viewing direction of at least one eye of an observer in real time. In this case, the resolution, the degree of detail, and/or the holographic quality of the preferably three-dimensional scene to be displayed is adapted on the basis of the present and/or predicted viewing direction of an eye of an observer. The resolution, the degree of detail, and/or the holographic quality of the scene can be reduced in the edge area of the fovea of the eye or in the edge area of the displayed scene, by which the power consumption in the at least one hologram computation circuit for computing the hologram of the scene can be influenced and thus reduced. The viewing direction of the eye of the user is computed for this purpose. Due to delays in the system made up of pre-computation, computation, and output of the hologram between start of the computation of the hologram and the subsequent display of the hologram on the at least one spatial light modulation device, the viewing direction movement of the eye of the observer of the scene can be predicted or estimated in the future in accordance with the delay time.

In a further advantageous embodiment of the invention, it can moreover be provided that occlusion data of the scene to be displayed are transmitted to the preprocessing circuit, where the preprocessing circuit extracts the required information for generating object points of the scene from the transmitted occlusion data.

Further functions of the preprocessing device or, viewed generally, the preprocessing circuit are the control of further components of at least one spatial light modulation device and/or holographic display apparatus, in general synchronously with the output of the computed holograms on the at least one spatial light modulation device. In other words, controllable components of a holographic display apparatus for displaying the scene can be activated by means of the preprocessing circuit, where the control of the components takes place synchronously to the output of the computed hologram on the at least one spatial light modulation device.

These include, among other things, the activation of an illumination device, in particular of at least one light source or a backlight, the processing of eye tracking data, as explained above, and the supply of these data to relevant components, the activation of components for light deflection or tracking of at least one visibility range/observer window, the control of active optical elements for modulation and manipulation of the light waves in the spatial light modulation device.

Furthermore, the preprocessing circuit can also perform the following functions. For example, the preprocessing circuit can carry out a conversion of two-dimensional (2D) data of a scene into three-dimensional (3D) data of a scene, i.e., a so-called 2D/3D conversion. A generation of depth data from multiple views of a three-dimensional scene is also possible. Moreover, additional three-dimensional data can be generated to fill shadows in the scene due to the holographic parallax, i.e., generation of occlusion data, as already mentioned above. This generation can in particular take place with the aid of point cloud-type data of a three-dimensional scene or if multiple image planes with/without transparency are provided.

A further task of the preprocessing circuit is the distribution of the data to be calculated of the preferably three-dimensional scene to be displayed to one or more hologram computation circuit(s). This takes place via a data interface device. For this purpose, the data generated using the preprocessing device of the preprocessing circuit can be converted into a system-independent format in consideration of specific parameters of the at least one spatial light modulation device and transmitted via an output interface device of the preprocessing circuit to the at least one hologram computation circuit to compute a hologram of the scene to be displayed.

The specific parameters of the at least one spatial light modulation device, data, and programs for preprocessing the received scene to be displayed can be transmitted in an encrypted form to the preprocessing circuit, where these data, parameters, and programs can be stored previously encrypted on a nonvolatile memory. The nonvolatile memory can be provided externally or internally, i.e., outside or inside the preprocessing circuit. In this way, an external or unauthorized access from outside is not possible or is made more difficult.

A timing controller can be provided or used in the preprocessing circuit for generating defined signals. The at least one spatial light modulation device and at least one source driver provided for this purpose for driving the at least one spatial light modulation device can thus be clocked and controlled via a timing controller of the preprocessing circuit. The timing controller is moreover also designed to activate further components and circuits. The computed data of the preferably three-dimensional scene to be displayed can also be transferred into the pixels or pixel cells of the spatial light modulation device using the timing controller. The hologram computation circuits, in the case of the provision of multiple hologram computation circuits, can be synchronized in accordance with this control of the spatial light modulation device by means of the timing controller for smooth and efficient operation.

In one particularly advantageous embodiment of the invention, it can be provided that at least one analysis, i.e., one or more analyses, of the data of the scene to be displayed is carried out for a hologram normalization within the preprocessing circuit.

The preprocessing circuit is advantageously designed so that a hologram normalization can be carried out by means thereof, preferably in the hologram computation circuit. In this way, the normalization of a hologram is not carried out in the step of computing the hologram by means of the circuit which executes the computation, i.e., the hologram computation circuit, but rather can be carried out by a separate circuit, here the preprocessing circuit, which is not tasked with the direct computation of a hologram. This has the enormous advantage that the circuit for computing a hologram, the hologram computation circuit according to the invention here, no longer requires a large memory capacity in order to buffer a complete data set of a hologram. This is because the normalization of a hologram can be carried out according to the invention without buffering or without a buffer memory.

The preprocessing circuit formed separately from the at least one hologram computation circuit carries out special and defined analyses on the basis of the data of the preferably three-dimensional scene to be displayed to implement a hologram normalization in the last step of the hologram computation within the hologram computation circuit, the encoding, in order to enable an approximately correct hologram normalization. For this purpose, the at least one hologram computation circuit therefore does not require a buffer memory, so that this circuit can be produced more inexpensively and smaller in its dimensions, which enables more cost-effective production.

A determination of hologram normalization parameters for hologram normalization can advantageously be carried out here by an analysis of the data transmitted to the input interface device of the preprocessing circuit. The following steps are performed for this purpose:
analyzing a distribution of object points of the scene with respect to their depth and their lateral distribution in an observation area,
analyzing a brightness distribution of the object points in combination with the respective depth of the object points in the observation area, and
determining a total number of the object points.

The hologram normalization is therefore based on an analysis of a data stream coming into the preprocessing circuit, in that features of the distribution of object points in the observation area, the brightness distribution of the object points in the observation area, and the total number of the object points are observed and assessed to ascertain the degree of filling of the scene. These items of information can be analyzed by statistical methods and stored, for example, in histograms to be able to read the relevant parameters for normalization in an efficient manner. Further statistical data on the structure, the distribution, and the design of the preferably three-dimensional scene can additionally be determined.

By analyzing the change of the scene to be displayed from frame to frame, hologram normalization parameters can be estimated by an analysis module in the preprocessing circuit and transmitted to an encoding module in the at least one hologram computation circuit, which applies these estimated hologram normalization parameters to the computed passing hologram data for normalization.

This means that the change of the hologram normalization parameters to be expected can be estimated by the analysis of the change of the preferably three-dimensional scene from frame to frame. This estimation is transmitted to the encoding module in the at least one hologram computation circuit, which applies the estimated parameters for normalization to the passing hologram data. According to the invention, the hologram is therefore not buffered as in the prior art, but rather further processed directly as it passes. At the same time, the encoding module determines the actual correct value of the hologram normalization parameters on the basis of the passing data of the preferably three-dimensional scene and returns this value at the end of the frame to the analysis module in the preprocessing circuit. In other words, by means of the passing computed data for the hologram encoding, correct values of the hologram normalization parameters can be determined by the encoding module and transmitted back to the analysis module in the preprocessing circuit. This analysis module uses this correct measured value of the past frame for error assessment and dynamic adaptation, the so-called fine tuning, in order to improve the renewed estimation of the hologram normalization parameters for the next frame.

In summary, it may be stated that an estimation of the new hologram normalization parameters for the present frame of the scene is carried out by the analysis of the change of the present, preferably three-dimensional scene and the use of the known correct hologram normalization parameters of the last frame of the scene.

For example, in general the following relationships or rules can be defined for the estimation of the normalization parameters of a hologram:
If the three-dimensional scene becomes lighter or darker in its brightness on average from frame to frame, the maximum magnitude in the hologram has to be increased or reduced, since on average the magnitudes in the hologram are increased or reduced.
For the preceding relationship, the brightness dynamic of the scene additionally also has to be taken into consideration, however. In order that a dark scene can be reproduced appropriately darkly, for example, the maximum magnitude in the hologram accordingly has to be defined and set high. This means that the ratio of scene brightness to maximum brightness has to be taken into consideration in the selection of the maximum magnitude in the hologram and should approximately be the ratio of maximum magnitude of the hologram to set maximum magnitude.
In contrast, if the preferably three-dimensional scene becomes deeper (more extended) or compressed, i.e., if the object points of the three-dimensional scene change their distance to the observer, the maximum magnitude of the hologram should or has to be increased or reduced accordingly.

These rules or algorithms for controlling the normalization only form one example. Arbitrary variants and combinations thereof are therefore possible and are defined in dependence on the type and the properties of the at least one spatial light modulation device for which the computed and normalized hologram is encoded.

The application of methods of machine learning or artificial intelligence (AI) instead of permanently defined rules is also a preferred embodiment, in that in the scope of a training step for various preferably three-dimensional reference scenes, the behavior to be expected is specified and thus trained, so that in the phase of the application of the AI in new unknown three-dimensional scenes, good estimated values are determined for the normalization of the hologram by the AI. In this embodiment of the invention, the estimation is executed on the basis of the trained AI model without having drawn up specific rules.

After application of the estimated hologram normalization parameters to the hologram, a comparison of how good the estimation was is carried out at the end of a present frame with the aid of the determined actual hologram normalization parameters. The estimated hologram normalization parameters and the correct values of the hologram normalization parameters are therefore compared to one another at the end of each frame, i.e., after a complete pass of the presently computed hologram. Possible brightness deviations resulting therefrom in the reproduction and display of the preferably three-dimensional scene can then still be compensated for by slight variation of the exposure time by the illumination device or a light source on the spatial light modulation device, since the data for the preferably three-dimensional scene to be displayed have up to this point only been inscribed in the spatial light modulation device, but the exposure of the hologram encoded for the spatial light modulation device only starts thereafter, in order to reconstruct the scene. For the case of an absolutely incorrect estimation of the hologram normalization parameters, the light source of the illumination device, for example a laser, can temporarily not even be switched on at first, in order to avoid incorrect displays of the preferably three-dimensional scene. This incorrect frame is then skipped, which appears as a black screen to the observer. Since now the correct hologram normalization parameter is known, the following estimations of the hologram normalization parameters will again be nearly correct. Such cases can usually only occur in the event of very abrupt scene changes in the received, preferably three-dimensional scenes. Due to the high frame rate of spatial light modulation devices, omitting or not displaying a frame (resulting in a black frame) would hardly be perceived by an observer of the reconstructed scene. A black frame is at least significantly less noticeable or disturbing in its perception by the observer than an incorrectly normalized hologram, which at worst appears like a flash.

As known from US 2016/0132021 A1 and also described above, object points of a scene to be reconstructed are each encoded in subholograms on a spatial light modulation device and superimposed to form an overall hologram. In order to simplify the encoding of the subholograms, a reduced scene point description or object point description according to the invention can be used. The designation ‘reduced object point description’ is used for this hereinafter. This reduced object point description according to the invention is performed in the preprocessing circuit according to the invention. In other words, the preprocessing circuit according to the invention is designed so as to execute or perform a reduced object point description. The following calculations are carried out for a phase profile of a subhologram of an overall hologram for such a reduced object point description according to the invention. This can take place in approximated form, if this appears advantageous.

First, the focal length f is calculated corresponding to the distance of the object point from the spatial light modulation device, on which the object point is to be encoded as a subhologram:

$$f = \frac{dz}{d - z} ,$$

where z is the distance of the object point to the spatial light modulation device, where z is a positive value if the object point is between the spatial light modulation device and an observer, and d is the distance of the observer to the spatial light modulation device.

The phase of each pixel of the subhologram is then calculated as follows:

$$Φ ( {r}_{xy} ) = \frac{2 π}{λ} f ( 1 - \sqrt{1 + {( \frac{{r}_{xy}}{f} )}^{2}} ) + {Φ}_{0} ,$$

wherein λ is the wavelength of the light used, r_{xy} is the radius of the respective complex subhologram pixel from the center of the subhologram, ϕ₀ is the phase offset of the object point, and f is the above-calculated focal length.

It follows therefrom that the phase profile can be described using the focal length f instead of the actual distance of an observer to the spatial light modulation device and to the object point or scene point. Moreover, the nonlinearities over the depth range of the scene disappear by way of this description. This is because in the area far behind the spatial light modulation device, viewed from the observer, the influence of object point shifts on the phase profile in the subhologram is very minor in the depth, while the influence of object point shifts on the phase profile in the subhologram in the area in front of the spatial light modulation device is large in contrast. The focal length thus permits more efficient transfer into digital form in comparison to the location description of the object point.

A regular equidistant two-dimensional structure of the complex hologram pixels in the spatial light modulation device is assumed here. In this structure of the hologram pixels, discrete values for the pixels are calculated in the distance of the pixels pₓ and p_{y} of the spatial light modulation device. If these variables are now normed, where, for example, the horizontal pixel pitch pₓ, abbreviated as p, can be used here, the phase of the pixel is calculated using the normed radius R_{xy}, the normed focal length F, and the normed wavelength L:

$$F = \frac{f}{p}$$

$$L = \frac{λ}{p}$$

$${R}_{XY} = \frac{{r}_{xy}}{p}$$

using the following formula:

$$Φ ( {R}_{xy} ) = 2 π \frac{L}{F} ( 1 - \sqrt{1 + \frac{{R}_{xy}^{2}}{{F}^{2}}} ) + {Φ}_{0} .$$

The normed radius R_{xy} is dimensionless, always has a positive value, and varies over the area of the subhologram. Its value can be permanently assigned to a discrete subhologram pixel within the subhologram generation. This can also be incorporated in a permanent manner in corresponding implementations of the at least one hologram computation circuit, by which a reduction of the complexity of the at least one hologram computation circuit is enabled and the reusability can be increased with varied individual parameters, such as exact wavelength or exact pixel pitch.

If, for example, in spite of a varied pixel pitch p, the aspect ratio of the pixel geometry is identical between two holographic display apparatuses, so that the normed radius R_{xy} is constant for a discrete subhologram pixel, this would not influence a significant part of at least one hologram computation circuit. Such simplifications can be utilized so that at least one hologram computation circuit supports multiple holographic display apparatuses, with high technical and economic efficiency at the same time.

The use of the actual pixel pitch as a norming parameter pₓ in the transfer of the normed focal length is not absolutely necessary. If this value is not used, the advantage still results of more efficient transfer between the preprocessing circuit and the at least one hologram computation circuit. In contrast, if the actual pixel pitch is used as a norming parameter or this is corrected in the at least one hologram computation circuit before the subhologram encoding to the actual pixel pitch, the assignment of circuit parts of the at least one hologram computation circuit to the normed radius R_{xy} can thus take place permanently, and the at least one hologram computation circuit would support multiple holographic display apparatuses in spite of this permanent assignment.

In this way, three parameters remain which describe the phase values for the pixels of a subhologram of an object point independently of the properties of a spatial light modulation device. The following three parameters determine the phase values of the subhologram:
the normed focal length F,
the normed wavelength L, and
a phase offset ϕ₀ of the object point.

The normed focal length, designated as the value F, is dimensionless but signed. Depending on whether the object point, viewed from the observer, is generated or reconstructed in front of or behind the spatial light modulation device, the value F has a positive or a negative sign. The generation of the object point can be compared to the imaging of a parallel beam by a convex or concave imaging system. Subholograms form such lenses or optical elements. The normed focal length F varies the depth plane of the object point in the observation area, in which the preferably three-dimensional scene can be reconstructed and observed. The singularity F=0 is avoided, however.

The normed wavelength, designated as the value L, is also dimensionless but is always positive and only varies in the event of change of the exposure of the spatial light modulation device.

The phase offset ϕ0 of an object point is a free parameter which is added to the phase of all pixels of the subhologram.

Viewed generally, in one embodiment of the invention it can therefore be provided that an object point of the scene to be displayed is encoded in each case in a subhologram, where for the description of phase values of the subhologram of an object point by the preprocessing circuit, the following parameters are determined and transferred to the at least one hologram computation circuit for computing the phase of the subhologram of the object point of the scene:
a focal length or refractive power, which varies as a function of a depth of the object point in the observation area, and
a phase offset of the object point.

The focal lengths for the description of the phase values of the pixels of the subhologram of an object point can advantageously be defined as the normed focal length F=f/p or its reciprocal value, where f is the focal length of the object point and p is a constant, which can preferably be defined at the pixel pitch of the at least one spatial light modulation device.

In practice, the calculation formula for calculating a phase profile of a subhologram of an object point can be approximated (“Fresnel approximation”), in order to reduce the complexity of the calculation of the phase. The Taylor series expansion can be used for this purpose, which results upon a termination after the first element:

$$Φ ( {R}_{xy} ) = 2 π \frac{L}{F} ( 1 - \sqrt{1 + \frac{{R}_{xy}^{2}}{{F}^{2}}} ) + {Φ}_{0}$$

$$Φ ( {R}_{xy} ) \approx - 2 π \frac{{R}_{xy}^{2}}{2 FL} + {Φ}_{0}$$

The value F′=F*L=f*λ/p² or

$${F}^{′} = FL = \frac{f λ}{{p}^{2}}$$

can now be introduced.

The value F′ is to be designated here as a wavelength-normed focal length, and is thus a signed dimensionless variable like the normed focal length F.

The focal length for the description of the phase values of the pixels of the subhologram of an object point in system-independent form can advantageously be defined as the wavelength-normed focal length F′=fλ/p² or its reciprocal value, wherein f is the focal length of the object point, λ is the wavelength of the light, and p is a constant, which can preferably be defined at the pixel pitch of the at least one spatial light modulation device.

The wavelength-normed focal length F′ now permits, for the case of the use of an approximated computation, the complete description of the phase profile of the subhologram of an object point, in addition to the phase offset ϕ₀.

The phase of the subhologram of an object point of the three-dimensional scene can advantageously now be computed using the formula:

ϕ(R_{XY})=−R_{XY}²/F′+ϕ₀

by means of the at least one hologram computation circuit, where R_{xy} is the radius of each pixel of the subhologram from its center normed to the pixel pitch, F′ is the wavelength-normed focal length of the object point, and ϕ₀ is the phase offset of the object point.

The wavelength-normed focal length F′ is now the only parameter which influences the relative phase distribution within the subhologram. This permits a further permanent interconnection of circuit parts or computation devices within the at least one hologram computation circuit with simultaneous reusability of the hologram computation circuit in various holographic display apparatuses. Parameters, for example the wavelength of the light, distances of the object points to the observer, or size of the pixels can vary in this case, which only changes the wavelength-normed focal length F′ in its value, but not the at least one hologram computation circuit.

The use of the actual pixel pitch as a norming parameter pₓ upon the transfer of the wavelength-normed focal length is not absolutely necessary. If this value is not used, the advantage of more efficient transfer between the preprocessing circuit and hologram computation circuit then still results. In contrast, if the actual pixel pitch is used as a norming parameter or if this is corrected in the hologram computation circuit before the subhologram encoding to the actual pixel pitch, the assignment of circuit parts of the hologram computation circuit to the normed radius R_{xy} can take place permanently, and the one hologram computation circuit would support multiple holographic display apparatuses in spite of this permanent assignment.

An implementation of at least one hologram computation circuit, which only uses the above-described reduced parameters, preferably the wavelength-normed focal length F′, for the description of an object point of the scene at its input interface device, thus consists of an electronic circuit, which is implemented for a spatial light modulation device independently of the actual specific parameters. This hologram computation circuit according to the invention can thus be applied for various types of spatial light modulation devices upon the provision of various wavelengths, various distance ranges, and different pixel pitches. In this way, the hologram computation circuit can also be used for various holographic display apparatuses.

The specific parameters of the spatial light modulation device used therefore not only have to be known to the preprocessing circuit according to the invention or transmitted thereto, which converts the object points of the preferably three-dimensional scene to be displayed into the above-described reduced, independent object point description (system-independent format) and transfers it to the at least one hologram computation circuit. In other words, by means of the preprocessing circuit, an object point of the scene can be generated as a reduced object point description, converted into a system-independent format, and transferred to the at least one hologram computation circuit for computing the phase of the subhologram of the object point of the three-dimensional scene.

The use of the wavelength-normed focal length F′ or also the normed focal length on the interface between the preprocessing circuit and the at least one hologram computation circuit permits more efficient digital data transfer than in the case of the location description of the object point, since the nonlinearities disappear over the depth range of the scene by way of this description.

Of course, the values or data of F and F′ can also be transferred in mathematically derived form, for example, by multiplication with constants and/or transfer of the reciprocal value (i.e., a refractive power instead of a focal length), and in various digital data formats to the at least one hologram computation circuit.

It can be particularly advantageous if the phase value of pixels of the subhologram of the object point of the scene having equal distance from the center of the subhologram are computed using a circuit part of the at least one hologram computation circuit permanently assigned to this distance. In this way, the at least one hologram computation circuit can be simplified, which saves costs in the production and design and energy in its operation. Furthermore, the same hologram computation circuit can thus be used in a simple manner for various holographic display apparatuses.

There are now various possibilities for advantageously designing the teaching of the present invention and/or combining the described exemplary embodiments or designs with one another. For this purpose, reference is made, on the one hand, to the claims dependent on the other independent claims and, on the other hand, to the following explanation of the preferred exemplary embodiments of the invention on the basis of the drawings, in which generally preferred designs of the teaching are also explained. The invention is explained in principle here on the basis of the described exemplary embodiments, but is not to be restricted thereto.

In the figures:

FIG. 1: shows a graphic representation of an apparatus for computing a hologram according to the prior art;

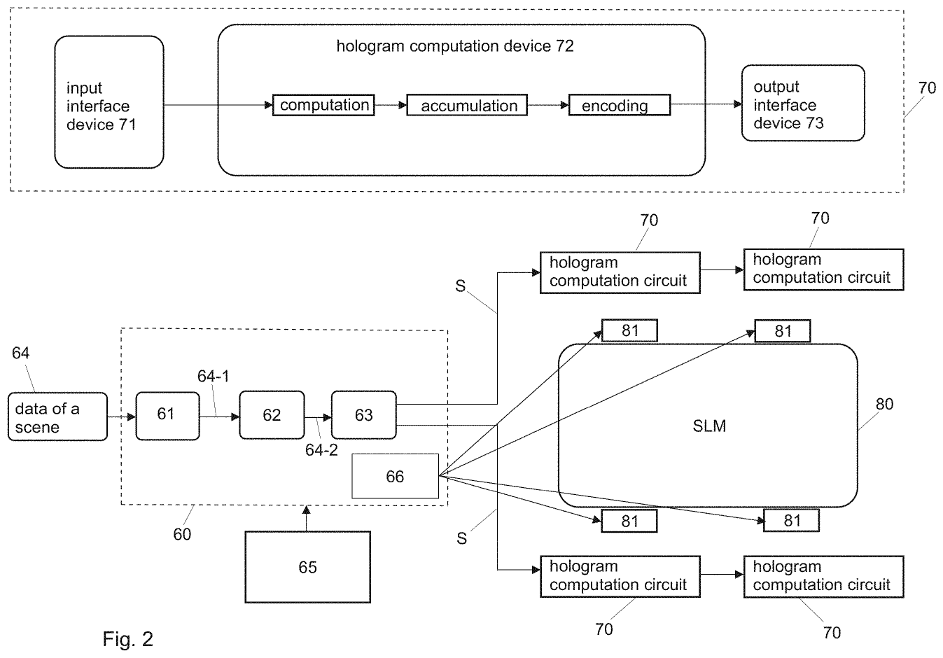

FIG. 2: shows a graphic representation of an apparatus or pipeline according to the invention for computing a hologram;

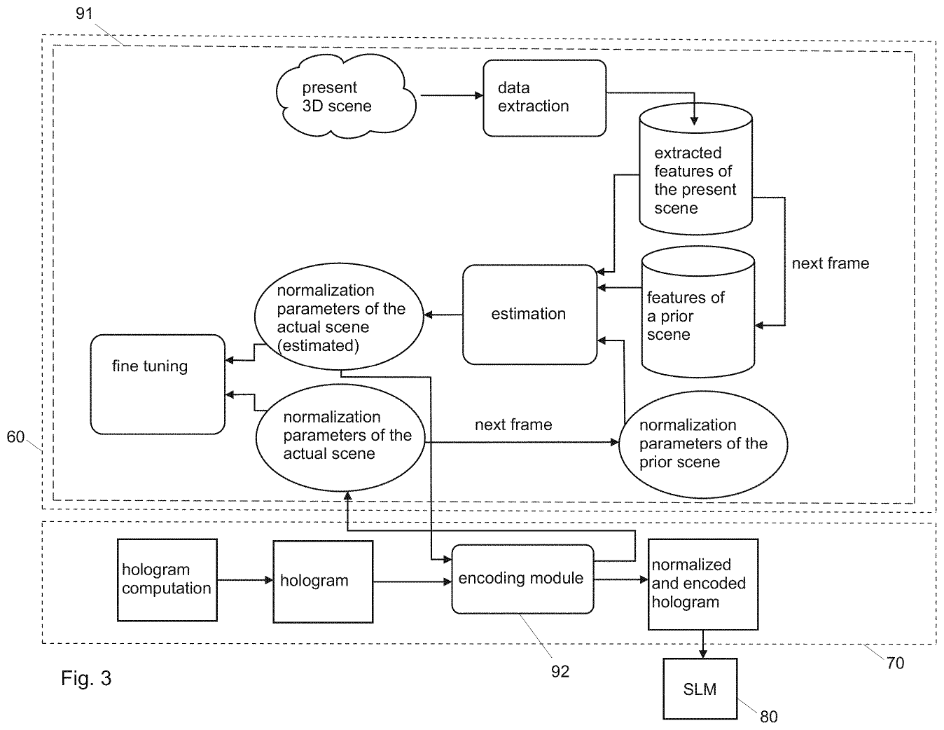

FIG. 3: shows a graphic representation of a method according to the invention for normalizing hologram data;

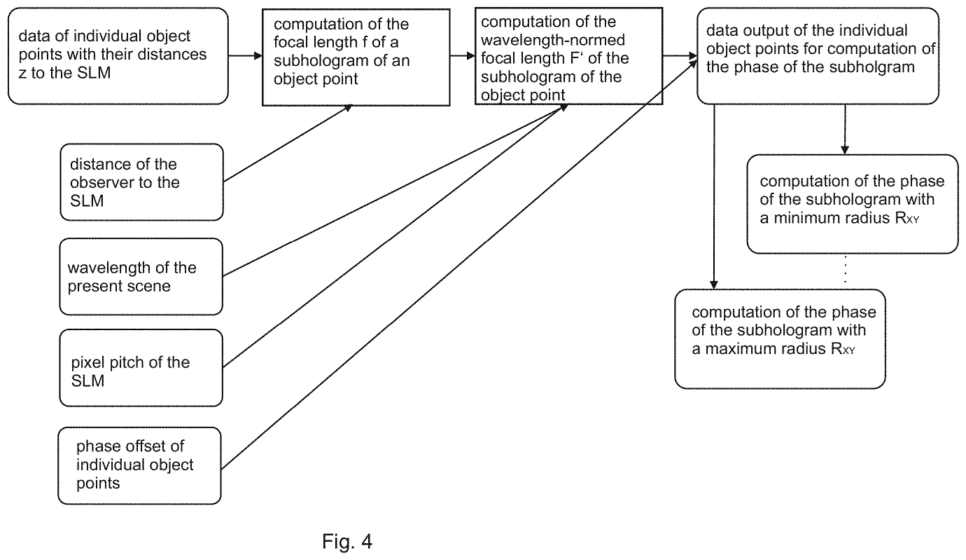

FIG. 4: shows a graphic representation of a method according to the invention for converting the data into a system-independent format; and

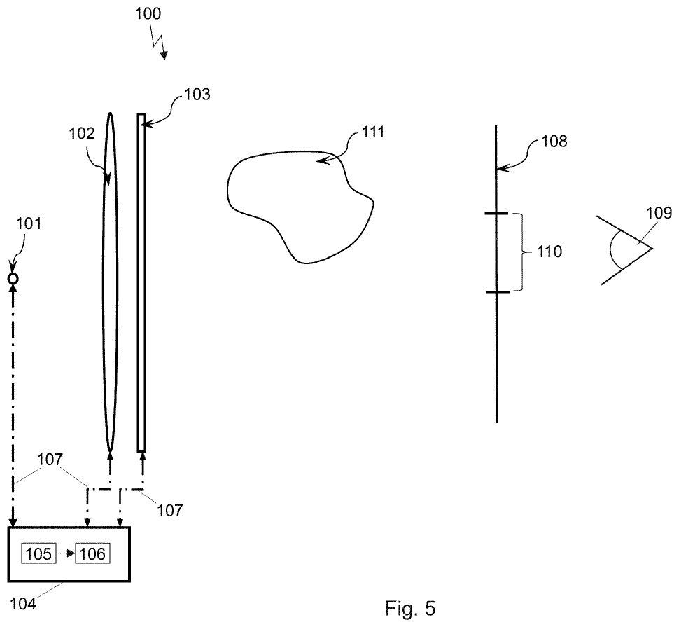

FIG. 5 shows in principle a holographic display apparatus according to the invention for reconstructing a preferably three-dimensional scene.

FIG. 2 shows a graphic representation of an apparatus according to the invention for computing a hologram. This apparatus in FIG. 2 simultaneously also represents a pipeline for real-time computation of holograms. The apparatus or pipeline according to the invention comprises a preprocessing circuit 60 and at least one hologram computation circuit 70. In the exemplary embodiment shown according to FIG. 2, multiple hologram computation circuits 40, a total of four in number here, are provided, where the number of the hologram computation circuits 70 can be dependent on the dimensions of a spatial light modulation device 80, referred to hereinafter as SLM, in which a hologram is encoded, which will be discussed in detail hereinafter. In principle, only one hologram computation circuit 70 can also be provided. The preprocessing circuit 60 and the hologram computation circuit 70 are each implemented as independent or separate circuits. They can therefore be viewed, produced, and sold as independent circuits. The preprocessing circuit 60 and the hologram computation circuit 70 can both be permanently connected to one another, however, for example wired, and in this way form an apparatus for computing a hologram according to FIG. 2. Both circuits 60 and 70 can each be implemented or embodied as a field-programmable gate array (FPGA) or as an application-specific integrated circuit (ASIC). In the present exemplary embodiment, the circuits 60 and 70 are each implemented as an ASIC.

The preprocessing circuit 60 is connected via a simple user-defined or customer-specific interface S to the hologram computation circuits 70. To generate and compute a hologram, which is then transferred to the SLM 80 and encoded for it, the preprocessing device 60 comprises an input interface device 61, a processing device 62, and an output interface device 63. The input interface device 61 receives data 64 of object points of a scene to be computed and encoded in a hologram, where a three-dimensional scene is presumed here. However, it is also possible to display a two-dimensional scene. The input interface device 61 can have for this purpose a standardized interface, for example, one or more DisplayPort or HDMI interfaces, one or more network interfaces, or also any other interface having the required bandwidth. The data 64 of the three-dimensional scene can be provided for this purpose in various formats. They can be designed, for example, as a three-dimensional point cloud, as a three-dimensional volume, or also as a compilation of scanned images or two-dimensional (2D) matrices of one or more views from one or more planes in an observation area, i.e., images in color representation and depth, possibly in multiple planes for implementing transparency or volume in holograms. Any other formats are also possible. The resolution of the data 64 is flexible, where a provided SLM, for which the computed hologram is then to be encoded, possibly implements a specific maximum resolution for the reproduction and reconstruction of the three-dimensional scene, however.

The data 64 which the preprocessing circuit 60 uses and programs which are executed on the preprocessing circuit 60 are supplied in an encrypted form via an external data interface to the preprocessing circuit 60. These data 64 and programs are moreover stored encrypted on an external, nonvolatile memory 65. The preprocessing circuit 60 uses a combination made up of permanent logic having paths switchable at the run time or once and at least one embedded processor having at least one processor core, where multiple processors or processor cores can also be used, on which one or more program(s) and modules run to carry out all required tasks for the pre-computation of holograms. An embodiment without the use of programs or processors is also possible, however.

Moreover, the input interface device 61 decrypts and processes the received data 64 of the three-dimensional scene according to the requirements of the processing device 62 and passes them on as data 64-1 to the processing device 62. The processing device 62 then processes these data 64-1 according to defined requirements for a hologram to be computed. This means that the processing device 62 carries out various preprocessing actions of the data 64-1 transmitted thereto. These can include, for example, the correction of aberrations in the three-dimensional scene to be displayed. The processing device 62 can also be defined so that effects having a negative effect on a three-dimensional scene to be displayed of an optical system provided in a holographic display apparatus can be corrected by this device. For example, a color correction and/or a position correction of the object points of the three-dimensional scene to be displayed can be performed by means of the processing device 62, in that the data 64-1 are preprocessed in such a way that this correction then takes place in the display of the scene. It is also possible to design the preprocessing actions of the data 64-1 so that different corrections are carried out for each wavelength (color) of the light, using which the SLM 80 is then illuminated for reconstruction of the three-dimensional scene, in order, if necessary, to compensate for wavelength-dependent effects in the optical system of the holographic display apparatus differently. Moreover, the processing device 62 can also perform preprocessing actions for a defined correction of visual defects of at least one eye of an observer of the scene to be displayed. Such a subsequent correction of ocular visual defects can be carried out here in such a way that the object points of the three-dimensional scene are individually shifted, rotated, and/or distorted in each dimension or direction.

Using eye tracking data, i.e., for tracking the eyes of an observer in real time, for example to find out in which direction the viewer is presently looking or which part of the three-dimensional scene the observer aims or looks at at this moment, so-called foveated rendering can also be implemented, in that the resolution of the three-dimensional scene to be displayed is adapted on the basis of the present or predicted viewing direction of an eye of the observer. For this purpose, the resolution, the degree of detail, and/or the holographic quality of the scene can advantageously be reduced in the edge area of the fovea of the eye, by which the power consumption for computing the scene in the hologram computation circuit is significantly reduced. In defined areas of the field of view of the observer, the resolution, the degree of detail, and/or the holographic quality of the three-dimensional scene can thus be adapted accordingly. It is advantageous here to reduce the resolution, the degree of detail, and/or the holographic quality in the edge area of the three-dimensional scene. The viewing direction of the eye of the observer is computed for this purpose. Due to delays in the circuits 60 and 70 between the start of the computation and subsequent display of the hologram on the SLM 80, it is necessary to predict or estimate the viewing direction movement of the eye of the observer in the future in accordance with the delay time.

The preprocessing circuit 60 moreover also assumes the control of further components of the SLM 80, where the control generally takes place synchronously to the output of the holograms on the SLM 80. The processing device 62 of the preprocessing circuit 60 can also assume or carry out further functions. These can include, for example, a conversion of two-dimensional (2D) scene data into three-dimensional (3D) scene data, i.e., a so-called 2D/3D conversion, a generation of depth data from multiple views of a three-dimensional scene, or also a generation of additional three-dimensional data for filling shadows due to the holographic parallax (so-called occlusion data). Occlusion data can be generated in particular with the aid of point cloud-like three-dimensional scene data or if multiple image planes with/without transparency are provided. The occlusion data of the scene are transmitted in this case to the preprocessing circuit 60. The preprocessing circuit 60 then extracts the required information from these data in order to be able to generate the object points of the scene from the transmitted occlusion data.

After the processing device 62 has accordingly preprocessed or processed the data 64-1, these now preprocessed and optionally corrected data 64-2 of the three-dimensional scene are subsequently converted into a generalized format processable for the following hologram computation circuits 70 or into a system-independent format. Specific parameters of the SLM 80 are also incorporated in the conversion of the data 64-2 for this purpose. These parameters are, for example, items of information on the wavelengths used of the light incident on the SLM 80, the scanning of the SLM 80, resolutions of the SLM 80, on distances, for example distances between an eye of an observer and the SLM 80, correction tables and correction parameters, in order to carry out specific corrections, for example, of distortions or wavelength-dependent aberrations, items of interface information, interface configurations, and interface parameters.

The converted data 64-2 are transmitted to the output interface device 63, which transmits these preprocessed data 64-2 for computing a hologram to the individual separate hologram computation circuits 70 at a low bandwidth.

As is apparent in FIG. 2, four hologram computation circuits 70 are used here, which follow the separate preprocessing circuit 60. Like the preprocessing circuit 60, the hologram computation circuits 70 are also each designed as independent or separate circuits and preferably implemented here as ASIC. An implementation of the hologram computation circuits 70 as FPGA is also possible and could be more cost-effective depending on the number of the hologram computation circuits used or the number of the apparatuses to be produced (piece counts). As already mentioned, it can be advantageous to use not only one hologram computation circuit 70 in the number, but a defined number of multiple hologram computation circuits 70. The number of hologram computation circuits 70 advantageously to be used results from the required computing power which is necessary for the hologram, and the required bandwidth in the transmission of the hologram to the SLM 80. The computing power and the bandwidth generally also scale with the size or dimensions of the SLM 80. This means that the larger the SLM 80 is in its dimensions, the more advantageous it is to use a larger number of hologram computation circuits 70. The provision of multiple hologram computation circuits 70 moreover has the advantage of more uniform dissipation of the resulting waste heat via multiple small spots (hotspots) instead of one large spot in the case of only one hologram computation circuit 70 in the computation of a hologram. In FIG. 2, each two hologram computation circuits 70 are connected in parallel to one another, where the respective two hologram computation circuits 70 are connected in series to one another or form a series circuit. Of course, other possibilities for arranging the hologram computation circuits in relation to one another and to the SLM are also possible. In this way, each two hologram computation circuits 70 are arranged on two opposite sides of the SLM 80, so that two separate lines or transfer lines S are connected from the preprocessing circuit 60 to the respective hologram computation circuit 70 provided first in the series. The second hologram computation circuit 70 provided in the series is connected here via a corresponding line to the first hologram computation circuit 70, as is apparent from FIG. 2. The proximity of the hologram computation circuits 70 to the edge of the SLM 80 or to source drivers 81 of the spatial light modulation device enables short data lines, which significantly reduces the power consumption at the very high data rates.

The hologram computation circuits 70 can thus be located close to the connections of the SLM 80. It is also possible to integrate the hologram computation circuits into the SLM 80 as part thereof. In this case they can be provided in the vicinity of source drivers. Present developments could also give the impetus that such hologram computation circuits or circuits could be applied directly to a substrate of the SLM (chip on glass).

The interface to the SLM 80 is designed flexibly here and enables an adjustment of the data rate, the number of transfer lines, and the protocol to be used. For this purpose, in the production of the SLM 80 in conjunction with the hologram computation circuit(s) 70, the corresponding data paths can be permanently activated or configured on the hologram computation circuit 70. This can take place, on the one hand, at the run time upon the initialization of the hologram computation circuit 70 or can be permanently set via configuration bridges (antifuses).

An aspect particularly to be highlighted in combination with the generalized implementation of the hologram computation is the scalability. Such a hologram computation circuit 70 can be used multiple times within the apparatus or pipeline according to FIG. 2 and thus also multiple times in a holographic display apparatus for displaying three-dimensional scenes or objects. If certain requirements, for example, with respect to the aspect ratio of at least similar pixel pitch, are met, the same hologram computation circuit can also be used in various products of an apparatus according to FIG. 2 or a holographic display apparatus. This would be advantageous in particular with respect to the production costs of an ASIC or FPGA, because these can be enormous. Therefore, if the same type of ASIC or FPGA can be used multiple times in an apparatus, this would save a costly development and production of a hologram computation circuit according to the invention per product or apparatus. Smaller ASICs or FPGAs in their dimensions in comparison to an ASIC or FPGA large in its dimensions additionally have the significant advantage that a higher yield can be achieved in the production. The development and tests are therefore additionally less complex.

To reduce the power consumption and the piece count costs with respect to the hologram computation circuits, smaller process structures can be sought. This is worthwhile above all if high piece counts of hologram computation circuits are also planned, which is assisted by the generalization and the provision of multiple hologram computation circuits.

In principle, the provision of an independent hologram computation circuit and an independent or separate preprocessing circuit which is separate from the direct hologram computation advantageously enables marketing of the hologram computation circuit design and of the preprocessing circuit design. This in turn enables, for example, a producer of an SLM or a holographic display apparatus to adapt to their own processes and interfaces, and to use production methods which are their own or are suitable for them.

By means of the hologram computation circuits 70, after the transmission of the preprocessed data 64-2 of the three-dimensional scene by the preprocessing circuit 60, data for a required hologram of a scene, which is formed from computed and superimposed subholograms of object points of the scene, are now computed. The first hologram computation circuit 70 connected in series in each case according to FIG. 2 only extracts the required data in each case for the computation of a part of the hologram from the transmitted data for computing the hologram and transfers the remaining data to the second hologram computation circuit 70 provided in the series, which uses these data to also compute a part of the overall hologram or hologram. The data stream is conducted unchanged through the hologram computation circuits 70, where each hologram computation circuit 70 only extracts the data for computing the hologram which it requires. For this purpose, the hologram computation circuit 70 according to the enlarged illustration in FIG. 2 has an input interface device 71, a hologram computation device 72, and an output interface device 73. The input interface device 71 receives the data 64-2 of the three-dimensional scene, which are preprocessed by the preprocessing circuit 60 and are provided in a system-independent format, and transmits them to the hologram computation device 72 to compute a hologram. In the hologram computation device 72, the computation of the hologram, the accumulation of the individual subholograms of object points of the three-dimensional scene to form the overall hologram of the scene, and the encoding of the hologram take place here, as shown in FIG. 2. The computed hologram of the three-dimensional scene or the computed data of the hologram to be encoded are then transferred to the output interface device, which then outputs these data to source drivers 81. The source drivers 81 in turn transfer the data of the encoded hologram to the SLM 80, in which the computed and encoded hologram of the required three-dimensional scene is then inscribed.

For this purpose, a timing controller 66 (TCON) can be implemented in the preprocessing circuit 60. This timing controller 66 is used here to generate control signals, synchronization signals, and/or clock signals, so that the SLM 80 and the source driver 71 can be directly clocked and controlled. Furthermore, the timing controller 66 can also activate general components and circuits in order to drive the SLM 80 and transfer the data into the pixels or pixel cells of the SLM 80. The hologram computation circuits 70 are synchronized in accordance with this control of the SLM 80 for the smooth operation of the SLM 70.

Furthermore, the preprocessing circuit 60 assumes the overall control of the SLM 80 and components of a holographic display apparatus, which the SLM 80 has, i.e., all electronic or controllable components, for example, at least one light source of an illumination device or a device for deflecting light. A control of active optical elements for modulation and manipulation of incident light waves in the SLM 80 or the holographic display apparatus with the goal of synchronous and efficient operation and interaction is also possible by means of the preprocessing circuit 60.

The preprocessing circuit 60 only carries out special tasks, in which many functions with respect to calibration of the SLM 80, corrections of the hologram, and adaptation/upgrading of the three-dimensional scene are implemented. This is because at least one preprocessing circuit 60 for activating the at least one hologram computation circuit 70 is required per SLM product or holographic display apparatus. By way of various measures, such as protected non-externally readable data areas (EEPROMs), which are externally writable, but are only internally readable, in the preprocessing circuit 60, encryption technologies, for example, TSL or SSL, can be used in order to implement a mutual authentication of hologram computation circuit 70 and preprocessing circuit 60 for the purpose of an authenticity check between these two circuits 60 and 70 and to encrypt transfer channels. For this purpose, private keys can be stored in the protected area of the preprocessing circuit 60, which are required for decrypting the terminal parameters and programs on the external (or internal) nonvolatile memory 65. The preprocessing circuit 60 and the hologram computation circuit(s) 70 can mutually authenticate one another in this way, to each prove their authenticity. If this authentication were to fail, for example, the respective circuit, preprocessing circuit 60 and/or hologram computation circuit 70, could be put into a special invalid mode. This could have the effect that, for example, a corresponding item of information is overlaid in the SLM 80, the operation of the SLM or a holographic display apparatus is stopped, or the displayed three-dimensional scene is also displayed at a significantly reduced quality. However, these are only a few examples, where other possibilities of an invalid mode are also possible, of course.

FIG. 3 shows a sequence of a method for normalizing holograms. According to the prior art, buffering of a hologram is necessary to perform a normalization of the complex-valued data of the three-dimensional scene in the context of the encoding step, in order to enable the display of the data on pixels of the SLM having limited resolution. For this purpose, the complete data set, i.e., the complete hologram in full value resolution is required in order to determine the hologram normalization parameters before the normalization can be executed on discrete values. For this purpose, the hologram can be buffered in an external memory or stored in the circuit itself. However, these methods are costly and have a high power consumption.

To avoid these disadvantages, the buffer memory is avoided in the method according to the invention, so that the complexity and the power consumption of the hologram computation circuit 70 can be reduced by orders of magnitude. The method according to the invention for normalizing a hologram according to FIG. 3 is thus carried out without buffering of the complete data set or the complete hologram.

A hologram normalization within the meaning of the application can be viewed as the simplest method, for example, the definition of a maximum absolute value of all complex numbers in the hologram, i.e., for example, a maximum magnitude/amplitude. Other normalization methods or combinations thereof are also possible, for example, a normalization based on histograms.

To implement the hologram normalization in the last step in the hologram computation, the encoding, the preprocessing circuit 60 carries out special analyses, i.e., at least one analysis, on the basis of the data of the three-dimensional scene in order to enable an approximately correct hologram normalization, without the hologram computation circuit 70 requiring a buffer memory or an external memory. However, an absolutely exact normalization of the hologram data is not required, since a small deviation would only result in a barely perceptible variation in the displayed brightness of the hologram. The method for normalizing a hologram is based on an analysis of the incoming data stream. The following described features of the three-dimensional scene are observed in this analysis. The distribution of the object points of the three-dimensional scene is analyzed or assessed with respect to their depth and their lateral distribution in the observation area. Furthermore, the brightness distribution of the object points is analyzed or assessed in combination with the respective depth of the object points in the observation area. In addition, the total number of the object points of the three-dimensional scene is ascertained in order to determine the degree of filling of the scene in the observation area. These items of information can each be analyzed and studied by statistical methods. The analyzed items of information can be stored, for example, in histograms in order to be able to read the relevant parameters for normalizing a hologram efficiently. Of course, it is possible to analyze further statistical data of the three-dimensional scene.

Due to the analysis of the change of the three-dimensional scene from frame to frame, the change of the hologram normalization parameters to be expected can be estimated. These estimated hologram normalization parameters by the preprocessing circuit 60 are transmitted to an encoding module in the hologram computation circuit 70, which applies the estimated parameters for normalization to the passing hologram data. In this method according to FIG. 3, the computed hologram is therefore not buffered in the hologram computation circuit 70 or an external memory, but rather further processed directly in passage. At the same time, the encoding module ascertains the actual correct value of the hologram normalization parameters on the basis of the passing data of the hologram and returns this value at the end of the present frame to an analysis module 91 in the preprocessing circuit 60. This analysis module 91 uses this correct measured value of the past frame for error assessment and dynamic adaptation, so-called fine tuning, of the hologram normalization parameters in order to improve the renewed estimation for the next frame.

In this way, an estimation of the new normalization parameters for the hologram for the present frame can be carried out by an analysis of the change of the present three-dimensional scene and use of the known correct hologram normalization parameters of the last frame.

In general, the following relationships or rules can be defined for the estimation of the normalization parameters for a hologram. These include, for example:
If the three-dimensional scene or sequence of scenes becomes lighter or darker on average in its light intensity during its display from frame to frame, the maximum magnitude is to be increased or reduced, since on average the magnitudes in the hologram increase or decrease.
Additionally, however, the brightness dynamic of the scene is also to be taken into consideration. In order that, for example, a scene which is dark in its light intensity can accordingly also be reproduced dark, the maximum magnitude in the hologram is accordingly to be defined high, i.e., the ratio of scene brightness to maximum brightness is also to be taken into consideration in the selection of the maximum magnitude and is approximately to be the ratio of maximum magnitude of the hologram to set maximum magnitude.
In contrast, if the three-dimensional scene becomes deeper, i.e., more extended, or more compressed, which means that the object points change their distance to the observer, the maximum magnitude of the hologram is accordingly to be increased or reduced.

These rules or also algorithms for the estimation of the normalization parameters for a hologram only form examples, however, where arbitrary variants and combinations are possible. These can be defined in dependence on the type and the properties of an SLM used.

Methods of machine learning or artificial intelligence (AI) instead of permanently defined rules can also be applied. For this purpose, in the scope of a training step for various three-dimensional reference scenes, the behavior to be expected can be specified and therefore trained, so that in the phase of the application of the AI with new unknown three-dimensional scenes, good estimated values are ascertained by the AI for the normalization of the hologram. In this embodiment, the estimation of the normalization parameters is executed on the basis of the trained AI model, without having drawn up specific rules.

After application of the estimated hologram normalization parameters, at the end of the present frame, i.e., after a completed passage of the presently computed hologram, with the aid of the ascertained actual hologram normalization parameters, a comparison is carried out between these two parameters of how good the estimation was. Possible brightness deviations resulting therefrom in the reproduction of the three-dimensional scene to be displayed can still be compensated for by slight variation of the exposure time of the SLM by the at least one light source of an illumination device, since the data have only been written up to this point in the SLM, but the exposure of the hologram in the SLM is only performed thereafter. For the case of an absolutely incorrect estimation of the hologram normalization parameters, for example, the light source, for example a laser, can temporarily not even be put into operation or can be switched off in order to avoid incorrect displays of the three-dimensional scene. Such an incorrect frame can be skipped in this way, so that this frame becomes like a black screen to an observer. Since exact hologram normalization parameters are now known due to the computation of the hologram normalization parameters, the following estimations of the hologram normalization parameters in the illustrated cycle according to FIG. 3 are again nearly correct. Such cases of incorrect displays usually only occur in the event of very abrupt scene changes in the received three-dimensional scenes. Due to the high frame rate of SLMs, omitting a frame, i.e., a black frame, would hardly be perceived by an observer of the displayed three-dimensional scene. A black frame is at least significantly less noticeable or disturbing to an observer than an incorrectly normalized hologram, which can act like a flash.

A more detailed sequence of the method for normalizing a hologram will be described hereinafter on the basis of FIG. 3. The preprocessing circuit 60, which carries out the main part of the normalization of a hologram, comprises the analysis module 91, using which the normalization of a hologram is carried out. For a normalization of a hologram, present data of a three-dimensional scene to be displayed are provided for a first frame, as can be seen in the top left area of the analysis module 91. The data required for the determination of normalization parameters for the normalization of the hologram associated with this scene are extracted from these data. In this case, the data stream coming into the analysis module 91 is analyzed with respect to the above-mentioned features of the three-dimensional scene, i.e., for example, by determining the object points of the scene with respect to their depth, brightness, color, and their lateral distribution in the observation area, etc. The above-mentioned features of the scene to be analyzed are also to apply here, of course, and are also to be specified without these being mentioned in detail here once again. These extracted features of the three-dimensional scene or the extracted data are thereupon stored in histograms or a memory, so that the relevant parameters of the data can be read or extracted easily and efficiently. Moreover, these data for a following frame are stored in a further memory, so that these data as data of a last or prior frame can also be incorporated in the determination of the hologram normalization parameters for a scene of a following frame. The extracted stored features are now used for an estimation of the normalization parameters for the hologram of the three-dimensional scene. After the estimation of the hologram normalization parameters, present estimated hologram normalization parameters are then provided, which are transferred to an encoding module 92 in one or more hologram computation circuits 70, as shown in FIG. 3. The encoding module 92 then applies these estimated hologram normalization parameters for normalization to the passing hologram data, which are therefore not stored at any location. This means that the hologram is thus not buffered, but rather further processed directly as it passes. Moreover, the encoding module 92 ascertains, during the passage of the hologram, the actual correct value of the hologram normalization parameters on the basis of the passing data. At the end of the frame, this correct value of the hologram normalization parameters is transmitted back to the analysis module 91 of the preprocessing circuit 60 again. After the application of the estimated hologram normalization parameters to the passing hologram, the estimated hologram normalization parameters and the computed correct values of the hologram normalization parameters are compared to one another in the analysis module 91 and it is ascertained how good the estimation of the hologram normalization parameters has been. The deviations resulting therefrom, for example, brightness deviations in the reproduction of the three-dimensional scene, can then be compensated for or remedied via fine tuning, for example, by variation of the exposure time of the SLM by a light source of an illumination device. This is possible since the data of the normalized hologram have already been transferred and inscribed in the SLM, but an exposure for reconstruction of the three-dimensional scene has not yet taken place. The light source could also not be switched on at all to illuminate the SLM, if the deviation should be sufficiently large that the three-dimensional scene is incorrectly reconstructed or displayed.

After the transmission of the correct normalization parameters for the hologram of the three-dimensional scene to the analysis module 91, these hologram normalization parameters of the preceding frame of a three-dimensional scene are also incorporated in the estimation of the hologram normalization parameters for the next or following frame. The extracted data or features of the three-dimensional scene to be displayed in the next frame are also incorporated in this estimation for the next frame, which are again stored in the histogram or memory, and the data or features of the prior three-dimensional scene. The estimated hologram normalization parameters are transmitted to the encoding module 92 again and applied to the passing hologram data. At the same time, the encoding module 92 ascertains the correct value of the hologram normalization parameters, so that then both values, i.e., the estimated and correctly computed values, are compared to one another and if necessary the deviations are attenuated or eliminated via fine tuning. Due to the analysis of the change of the present three-dimensional scene to be displayed and the use of the correct hologram normalization parameters of the last frame of the scene, in this way an estimation of the new hologram normalization parameters is carried out for the present frame.

For following frames or three-dimensional scenes to be displayed, the procedure as described is used to perform a normalization of a hologram.

As can be seen in the hologram computation circuit 70 in FIG. 3, the hologram computation takes place therein, by which a hologram is generated or created. This hologram is transferred to the encoding module 92, in which the hologram normalization parameters are applied to the passing hologram. In this way, an encoded, normalized hologram is generated which is inscribed in the SLM 80.

A method is shown in FIG. 4, using which the data of the three-dimensional scene to be displayed which are processed or generated in the preprocessing circuit can be converted into a system-independent format or a dimensionless format.

As known, for example, from US 2016/0132021 A1, object points of a three-dimensional scene to be reconstructed are encoded by means of a holographic display apparatus in subholograms on an SLM. In order to generate the individual subholograms of the object points, for each pixel of the SLM in which the subhologram is encoded, the phase and the amplitude are computed, using which the light used to display the three-dimensional scene is modulated by the SLM. The phase results in this case in particular from parameters such as the distance or the spacing of an object point to be displayed from the SLM, the wavelength and the spacing of the pixels (pixel pitch). Following the computation of the polar coordinates amplitude and phase, a computing step is carried out, namely the transformation of the phase and the amplitude into the Cartesian space having real and imaginary values. This enables the accumulation or the superposition of the computed subhologram with other subholograms in the overall hologram.

The further foundations for hologram computation with subholograms are not to be described further here. These are known, for example, from US 2016/0132021 A1.

A reduced object point description is used for the conversion of the preprocessed data in the preprocessing circuit into a system-independent format. For this purpose, a phase profile of a subhologram of an object point is computed as follows, if necessary even in approximated form.

After data of individual object points of the three-dimensional scene to be displayed are provided with their distances z to the SLM in the preprocessing circuit, according to FIG. 4, the focal length f of a subhologram is computed in accordance with the distance of its object point to be displayed in the scene:

$$f = \frac{dz}{d - z} ,$$

wherein z is the distance of the object point to the SLM with positive values in the display of the object point between the SLM and an observer of the scene, and d is the distance of the observer to the SLM. The distance of the object point to the SLM is thus also incorporated in the computation of the focal length f, as shown in FIG. 4.

The phase of each pixel of the subhologram is then computed using:

$$Φ ( {r}_{xy} ) = \frac{2 π}{λ} f ( 1 - \sqrt{1 + {( \frac{{r}_{xy}}{f} )}^{2}} ) + {Φ}_{0} ,$$

wherein λ is the wavelength of the light used, r_{xy} is the radius of the respective complex subhologram pixel from the center of the subhologram, and ϕ₀ is the phase offset of the object point.

It can be established in this case that the actual distance of an observer to the SLM and to the object point is irrelevant for the phase profile of the subhologram of an object point if the focal length is known. The nonlinearities over the depth range of the observation area, in which the three-dimensional scene can be displayed, like the knowledge that, viewed from the observer of the scene, well behind the SLM, the influence of object point shifts on the phase profile in the subhologram is very minor in the depth, while the influence of object point shifts on the phase profile in the subhologram in front of the SLM is large in contrast, also become irrelevant.

If these variables are now normed, wherein here, for example, the horizontal pixel pitch pₓ, abbreviated as p here, or also another value can preferably be used here, the phase of the pixel is calculated using the normed radius R_{xy}, the normed focal length F, and the normed wavelength L:

$$F = \frac{f}{p}$$

$$L = \frac{λ}{p}$$

$${R}_{XY} = \frac{{r}_{xy}}{p}$$

using the following formula:

$$Φ ( {R}_{xy} ) = 2 π \frac{L}{F} ( 1 - \sqrt{1 + \frac{{R}_{xy}^{2}}{{F}^{2}}} ) + {Φ}_{0} .$$

The normed radius R_{xy} is a dimensionless value, which is always positive, and varies over the area of the subhologram. It measures the spacing of a pixel on the subhologram from the center of the subhologram. Its value can be permanently assigned to a group of discrete subhologram pixels with the same or a similar radius within the subhologram generation. The value R_{XY} can also be incorporated as a permanent variable in corresponding implementations of the at least one hologram computation circuit, by which a reduction of the complexity of the at least one hologram computation circuit is enabled and the reusability is increased with varied individual parameters, such as exact wavelength used or exact pixel pitch.

In this way, only three parameters still remain, which describe the phase profile of the subhologram of an object point of the three-dimensional scene independently of the properties of an SLM used. These three parameters are:
the normed focal length F, the value of which is dimensionless but is signed. This means that the sign is dependent on whether the object point, viewed from the observer, is generated in front of or behind the SLM, for example a convex or concave lens function is written in the subhologram. Moreover, the value of the normed focal length F varies depending on the depth plane of the object point in the observation area. However, the singularity F=0 is avoided.
The normed wavelength L, which is also dimensionless but is always positive. The value of the normed wavelength L only varies in the event of variation or change of the exposure of the SLM, however, and
the phase offset ϕ₀ of the object point.

It is advantageous to approximate the computation formula indicated above for the phase, in order to reduce the complexity of the computation of the phase. The Taylor series development with termination after the first element results in:

$$Φ ( {R}_{xy} ) = 2 π \frac{L}{F} ( 1 - \sqrt{1 + \frac{{R}_{xy}^{2}}{{F}^{2}}} ) + {Φ}_{0}$$

$$Φ ( {R}_{xy} ) \approx - 2 π \frac{{R}_{xy}^{2}}{2 FL} + {Φ}_{0}$$

A wavelength-normed focal length F′ can now be introduced, with:

$$\cdot {F}^{′} = FL = \frac{f λ}{{p}^{2}}$$

The wavelength-normed focal length F′ is thus, like the normed focal length F, a signed dimensionless variable. According to FIG. 4, it can now be computed for each subhologram of the individual object points of the three-dimensional scene. As is apparent in FIG. 4, the wavelength λ of the light used, i.e., the color in which the three-dimensional scene is to be displayed, and the pixel pitch of the SLM are also incorporated in the computation for this purpose.

These parameters, i.e., the wavelength A used to display the three-dimensional scene, the pixel pitch of the SLM, and also the distance d of the observer to the SLM are then no longer required in the hologram coding by means of the at least one hologram computation circuit.

The wavelength-normed focal length F′ now permits, for the case of the use of the approximated computation of the phase and with the incorporation of the phase offset ϕ₀, the complete description of the phase profile of the subhologram of an object point.

These data in the form of a reduced object point description are now provided as a system-independent format in the preprocessing circuit and are transmitted or transferred to the at least one hologram computation circuit to compute the hologram. By means of the at least one hologram computation circuit, the phase of the subhologram of an object point or a hologram is now computed using the formula:

ϕ(R_{XY})=−πR_{XY}²/F′+ϕ₀.

The wavelength-normed focal length F′ is therefore the only parameter which influences the relative phase distribution within the subhologram. This fact permits a strong simplification of the circuit parts or computation devices within the at least one hologram computation circuit, since only a division by the wavelength-normed focal length and the addition using the phase offset are used for a radius. If a normed radius R_{xy} is permanently assigned to a circuit part or computation device within the at least one hologram computation circuit, the factor R_{xy}² can also be defined in the circuit creation, which can mean a strong simplification of the at least one hologram computation circuit.

At the same time, the wavelength-normed focal length F′ increases a possible reusability of the hologram computation circuit in various holographic display apparatuses upon a variation of parameters, for example, the wavelength used, the distances of the scene and the SLM to the observer, or the aspect ratios of the pixels in the SLM. At the same time, the wavelength-normed focal length F′ increases the efficiency of the transfer, since the advantages of the focal length-scaled description apply.

The wavelength-normed focal length F′ thus represents a maximum system-independent description of the phase profile of a subhologram of an object point of the three-dimensional scene with simultaneous optimization options in the hologram computation circuit. The phase value of the pixels of the subhologram can now be computed with the aid of many similarly designed circuit parts of the at least one hologram computation circuit, where the circuit parts are each assigned a normed radius R_{xy} or normed distance of the pixels from the center of the subhologram and their radius or distance can be defined efficiently as a constant. These individual circuit parts now only still contain the division of a constant using the wavelength-normed focal length F′ and the addition using the phase offset ϕ₀.

An implementation of the at least one hologram computation circuit, which only uses the above-mentioned reduced parameters in the form of a system-independent format at its input interface device, above all the wavelength-normed focal length F′, thus consists of an electronic circuit which can be implemented independently of the specific parameters for an SLM and is thus usable for various types of SLMs having various wavelengths, various distance ranges between the scene, the observer, and the SLM, and different pixel pitch. In this way, it is possible that the hologram computation circuit can be used for various SLMs and various holographic display apparatuses.

The use of the actual pixel pitch as a norming parameter p in the transfer of the normed focal length is not absolutely necessary. If this value is not used, the advantage still results of more efficient transfer between the preprocessing circuit and hologram computation circuit. In contrast, if the actual pixel pitch is used as a norming parameter or this is corrected in the at least one hologram computation circuit before the subhologram encoding to the actual pixel pitch, the above-described assignment of circuit parts of the at least one hologram computation circuit to the normed radius R_{xy} can take place permanently, and the at least one hologram computation circuit would support multiple holographic display apparatuses in spite of this permanent assignment.

The specific parameters of the SLM therefore only have to be transmitted to the preprocessing circuit, which converts the data of the object points of the three-dimensional scene into the described reduced independent object point description or into the system-independent format and transfers them to the at least one hologram computation circuit.

The use of the wavelength-normed focal length F′ or also the normed focal length F at the interface between the preprocessing circuit and the at least one hologram computation circuit permits more efficient digital data transfer than in the case of the location description of the object point, since the nonlinearities disappear over the depth range of the scene due to this description.

Of course, the values or data of F and F′ can also be transferred in mathematically derived form, for example, by multiplication with constants and/or transfer of the reciprocal value, i.e., a refractive power instead of a focal length, and in various digital formats to the at least one hologram computation circuit.

A holographic display apparatus 100 for reconstructing or displaying a three-dimensional scene is shown in principle in a top view in FIG. 5.

The holographic display apparatus 100 comprises an illumination device, which has a light source 101 for emitting essentially coherent light, an optical system 102, which has at least one optical element, and an SLM 103 as a light-modulating optical element. A hologram is encoded in the SLM 103, which has pixels for light modulation, by means of an apparatus 104. By illuminating the SLM 103 using the essentially coherent light, the light is modulated by the hologram using the information of the three-dimensional scene to be displayed, so that a three-dimensional scene is reconstructed.

Furthermore, the holographic display apparatus 100 comprises the apparatus 104, which comprises a preprocessing circuit 105 and at least one hologram computation circuit 106, as described above and shown in FIGS. 2 to 4. The preprocessing circuit 105 and the at least one hologram computation circuit 106 are designed as independent or separate circuits and thus form the apparatus 104 as a combination. However, they can also be designed as separate independent circuits, which do not form an apparatus together. These circuits 105 and 106 thus have an array of functions and are configured to compute and encode a computer-generated hologram of a three-dimensional scene and to provide corresponding control signals for the at least one light source 101, the SLM 103, and, in a variant in which it can be regulated, for the optical system 102, as described with respect to FIGS. 2 to 4. For this purpose, the apparatus 104 is connected to these components via communication links 107.

The holographic display apparatus 100 moreover comprises an observer plane 108. However, this observer plane 108 is not a physically existing permanent plane. Rather, it is virtual and its distance to the SLM 103 can vary with the distance which an eye 109 of an observer has to the SLM 103. A visibility region or observer window 110 is defined in this observer plane 108, which is also virtual. The observer can observe a generated reconstructed three-dimensional scene 111 in the observer region, which can extend between the observer plane 108 and the SLM 103 and additionally beyond, if his eye 109 is at the location of the observer window 110 and he looks through it.

The three-dimensional scene 111 can be reconstructed here between the observer plane 108 and the SLM 103, for which the hologram is encoded. The three-dimensional scene can also be displayed and visible behind the SLM 103 viewed from the observer plane 108, however. It is also possible that a three-dimensional scene extends over the entire area, thus between the observer plane 108 and the SLM 103 and also behind the SLM 103.

The apparatus 104 is now designed or configured to carry out a method according to the invention as described above, using which the encoding of the SLM 103 using the computer-generated hologram is carried out by processing data only required once during the preprocessing for computing the hologram of the three-dimensional scene to be displayed by means of a preprocessing circuit and the actual computation of the hologram by means of the data provided by the preprocessing circuit is carried out by at least one hologram computation circuit. According to FIG. 4, the preprocessing circuit 105 provides the preprocessed data in a system-independent format to the at least one hologram computation circuit 106, as disclosed by the method of FIG. 4. Moreover, a normalization of the hologram is carried out by means of the preprocessing circuit 105, as described with respect to FIG. 3.

The invention is not to be restricted to the exemplary embodiments shown here.

Combinations of the exemplary embodiments, if possible, are also to be covered. Finally, it is very particularly to be noted that the above-described exemplary embodiments only serve to describe the claimed teaching, but the latter is not to be restricted to the exemplary embodiments.

1. A preprocessing circuit for at least one hologram computation circuit, comprising:
an input interface device for receiving data of a scene to be displayed,
a processing device for defined processing of the received data and for converting the data into a system-independent format with incorporation of specific parameters required for displaying the scene, and
an output interface device for outputting and transmitting the converted data to at least one hologram computation circuit.

2. The preprocessing circuit as claimed in claim 1, wherein the preprocessing circuit is implemented as a field-programmable gate array (FPGA) or as an application-specific integrated circuit (ASIC).

3. The preprocessing circuit as claimed in claim 1, wherein the data, parameters, and programs supplied to the preprocessing circuit are provided in an encrypted format.

4. The preprocessing circuit as claimed in claim 1, wherein the processing device is designed to correct imaging errors in the display of the scene.

5. The preprocessing circuit as claimed in claim 1, wherein the processing device is designed to correct imaging errors or to correct effects having a negative effect on a scene to be displayed of an optical system provided in a holographic display apparatus.

6. The preprocessing circuit as claimed in claim 1, wherein the processing device is designed in such a way that upon use of eye tracking data in conjunction with foveated rendering, the resolution, the degree of detail, and/or the holographic quality of the scene to be displayed is adaptable on the basis of a viewing direction of an eye of an observer in defined areas of a field of view of the observer.

7. The preprocessing circuit as claimed in claim 6, wherein, by means of the processing device, the data of the scene are processed in such a way that the resolution, the degree of detail, and/or the holographic quality of the scene is reduced in its edge area.

8. The preprocessing device as claimed in claim 1, wherein the processing unit is designed to control controllable components of at least one spatial light modulation device or a holographic display apparatus.

9. The preprocessing circuit as claimed in claim 1, wherein a combination of a permanent logic having paths switchable at the run time or paths switchable once at the run time and at least one processor is used in the processing device.

10. The preprocessing circuit as claimed in claim 1, wherein a timing controller is provided for generating control signals and/or synchronization signals.

11. The preprocessing circuit as claimed claim 2, wherein the processing device is designed to carry out analyses of the data of the scene to be displayed, in order to execute a hologram normalization.

12. The preprocessing circuit as claimed in claim 1, characterized by a scalability of the preprocessing circuit for various variables of the at least one spatial light modulation device and/or hologram resolutions and/or scene resolutions and/or parameters of the at least one spatial light modulation device by a variable activation of the computation paths.

13. An apparatus for computing a hologram for displaying a scene by means of a holographic display apparatus, which comprises at least one spatial light modulation device, comprising:
a preprocessing circuit as claimed in claim 1, and
at least one hologram computation circuit for computing a hologram and for encoding the hologram for the at least one spatial light modulation device.

14. The device as claimed in claim 13, wherein the at least one hologram computation circuit is implemented as a field-programmable gate array (FPGA) or as an application-specific integrated circuit (ASIC).

15. The device as claimed in claim 13, wherein the at least one hologram computation circuit comprises:
an input interface device for receiving data processed by the preprocessing circuit,
a hologram computation device for computing and encoding the hologram, and
an output interface device for transmitting the data of the computed hologram to the at least one spatial light modulation device.

16. The device as claimed in claim 13, wherein the at least one hologram computation circuit is designed as part of the at least one spatial light modulation device or is implemented directly on a substrate of the at least one spatial light modulation device.

17. The device as claimed in claim 13, wherein at least two hologram computation circuits are provided, which are connected in series and/or are connected in parallel to one another.

18. The device as claimed in claim 13, wherein a supply of data of the scene processed by the preprocessing circuit in a system-independent format to the at least one hologram computation circuit is provided.

19. The device as claimed in claim 18, wherein the at least one hologram computation circuit is designed in such a way that the data of the scene supplied in a system-independent format are directly usable and the hologram is computable.

20. The device as claimed in claim 13, wherein an external data interface device is provided for the encrypted supply of data and programs to the preprocessing circuit.

21. The device as claimed in claim 20, wherein the encrypted data and programs supplied to the preprocessing circuit are stored in encrypted form on a nonvolatile memory.

22. The device as claimed in claim 13, wherein a mutual authentication is implemented between the preprocessing circuit and the at least one hologram computation circuit.

23. The device as claimed in claim 13, characterized by a scalability of the preprocessing circuit and/or the at least one hologram computation circuit for various variables of the at least one spatial light modulation device and/or hologram resolutions and/or scene resolutions and/or parameters of the at least one spatial light modulation device by a variable activation of computation paths.

24. The device as claimed in claim 13, wherein the at least one hologram computation circuit is provided for various embodiments or designs of the at least one spatial light modulation device.

25. A holographic display apparatus comprising:
a preprocessing circuit as claimed in claim 1,
at least one hologram computation circuit for computing a hologram, and
at least one spatial light modulation device, for which the computed hologram is encoded.

26. The holographic display apparatus as claimed in claim 25, wherein at least one source driver is provided, using which data of the hologram computed using the at least one hologram computation circuit are transmittable to the at least one spatial light modulation device.

27. The holographic display apparatus as claimed in claim 25, wherein an illumination device, which comprises at least one light source, and an optical system are provided, by means of which a scene is reconstructable in conjunction with the at least one spatial light modulation device.

28. A pipeline for real-time computation of holograms, which comprises a preprocessing circuit for preprocessing data of a scene and for directly activating components of at least one spatial light modulation device and at least one hologram computation circuit for computing holograms, where the preprocessing circuit and the at least one hologram computation circuit are each implemented on the basis of a field-programmable gate array (FPGA) and/or an application-specific integrated circuit (ASIC).

29. The pipeline as claimed in claim 28, wherein the preprocessing circuit and the at least one hologram computation circuit are configurable at the run time.

30. The pipeline as claimed in claim 28, wherein the preprocessing circuit comprises a receiving interface device for receiving data for describing a scene to be displayed, a processing device for preprocessing the data of the scene to be displayed, and an output interface device for outputting and transmitting the preprocessed data to the at least one hologram computation circuit.

31. The pipeline as claimed in claim 28, wherein the at least one hologram computation circuit comprises an input interface device for receiving data preprocessed by the preprocessing circuit, a hologram computation device for computing and encoding a hologram, and an output interface device for transmitting the data of the computed hologram to at least one spatial light modulation device.

32. The pipeline as claimed in claim 28, wherein the preprocessing circuit and the at least one hologram computation circuit are separate circuits, which are connected to one another in such a way that the at least one hologram computation circuit is activatable by means of the preprocessing circuit, but the preprocessing circuit and the at least one hologram computation circuit are not assigned to a specific spatial light modulation device and/or holographic display apparatus.

33. The pipeline as claimed in claim 28, characterized by a scalability of the preprocessing circuit and/or the hologram computation circuit for various variables of the at least one spatial light modulation device and/or hologram resolutions and/or scene resolutions and/or parameters of the at least one spatial light modulation device by a variable activation of the computation paths.

34. A method for computing a hologram for displaying a scene by means of a holographic display apparatus, which comprises at least one spatial light modulation device, where the computation of the hologram is carried out by means of a preprocessing circuit and at least one hologram computation circuit.

35. The method as claimed in claim 34, wherein the preprocessing circuit processes data, which are only required once in the preprocessing to compute the hologram, and the at least one hologram computation circuit computes the hologram provided for encoding for the at least one spatial light modulation device from the data provided by the preprocessing circuit and outputs it to the at least one spatial light modulation device.

36. The method as claimed in claim 34, wherein an input interface device of the preprocessing circuit receives data of a scene to be displayed in encrypted format, decrypts them, and transmits them to a preprocessing device of the preprocessing circuit.

37. The method as claimed in claim 36, wherein by means of the preprocessing device, the transmitted data are preprocessed in accordance with the scene to be displayed and the preprocessed data are converted in consideration of specific parameters of the at least one spatial light modulation device into a system-independent format.

38. The method as claimed in claim 36, wherein aberrations of the scene to be displayed are corrected by the preprocessing device, by which data corrected for aberrations are generated.

39. The method as claimed in claim 36, wherein visual defects of an eye of an observer of the scene to be displayed are corrected by means of the preprocessing device by virtual shifting, rotation, and/or distortion of the scene.

40. The method as claimed in claim 36, wherein the resolution, the degree of detail, and/or the holographic quality of the scene to be displayed is adapted in consideration of a viewing direction of an eye of the observer by the preprocessing device in such a way that the displayed scene is computed in its edge area having a reduced resolution, a reduced degree of detail, and/or a reduced holographic quality by a hologram computation device of the at least one hologram computation circuit.

41. The method as claimed in claim 34, wherein occlusion data of the scene to be displayed are transmitted to the preprocessing circuit, where the preprocessing circuit extracts the required information for generating object points of the scene from the transmitted occlusion data.

42. The method as claimed in claim 36, wherein the data generated using the preprocessing device are converted into a system-independent format in consideration of specific parameters of the at least one spatial light modulation device and transmitted via an output interface device of the preprocessing circuit to the at least one hologram computation circuit for computing a hologram of the scene to be displayed.

43. The method as claimed in claim 34, wherein controllable components of a holographic display apparatus are activated to display the scene by means of the preprocessing circuit, where the control of the components takes place synchronously to the output of the computed hologram on the at least one spatial light modulation device.

44. The method as claimed claim 34, wherein in the specific parameters of the at least one spatial light modulation device, data, and programs for preprocessing of the scene to be displayed are stored in encrypted form on a nonvolatile memory, where these data are transmitted in encrypted form to the preprocessing circuit.

45. The method as claimed in claim 34, wherein the at least one spatial light modulation device and at least one source driver for driving the at least one spatial light modulation device are clocked and controlled via a timing controller of the preprocessing circuit.

46. The method as claimed in claim 34, wherein at least one analysis of the data of the scene to be displayed for a hologram normalization is carried out within the preprocessing circuit.

47. The method as claimed in claim 46, wherein to ascertain hologram normalization parameters for the hologram normalization, an analysis of the data transmitted to the input interface device is carried out by:
analyzing a distribution of object points of the scene with respect to their depth and their lateral distribution in an observation area
analyzing a brightness distribution of the object points in combination with the respective depth of the object points in the observation area, and
ascertaining a total number of the object points.

48. The method as claimed in claim 47, wherein by analyzing the change of the scene to be displayed from frame to frame, hologram normalization parameters are estimated by an analysis module in the preprocessing circuit and transmitted to a coding module in the at least one hologram computation circuit, which applies these estimated hologram normalization parameters to the computed passing hologram data for normalization.

49. The method as claimed in claim 48, wherein by means of the passing computed data for hologram encoding, correct values of the hologram normalization parameters are ascertained by the encoding module and transmitted back to the analysis module in the preprocessing circuit.

50. The method as claimed in claim 48, wherein the estimated hologram normalization parameters and the correct values of the hologram normalization parameters are compared to one another at the end of each frame.

51. The method as claimed in claim 34, wherein in each case an object point of the scene to be displayed is encoded in a subhologram, where to describe phase values of pixels of the subhologram of an object point, the following parameters are determined by the preprocessing circuit and transferred to the at least one hologram computation circuit for computing the phase of the subhologram of the object point of the scene:
a focal length or refractive power, which varies as a function of a depth of the object point in the observation area, and
a phase offset of the object point.

52. The method as claimed in claim 51, wherein the focal length for the description of the phase values of the pixels of the subhologram of an object point is defined as the normed focal length F=f/p or its reciprocal value, where f is the focal length of the object point and p is a constant, which is preferably defined on the pixel pitch of the at least one spatial light modulation device.

53. The method as claimed in claim 51, wherein the focal length for the description of the phase values of the pixels of the subhologram of an object point is defined in system-independent form as a wavelength-normed focal length F′=fλ/p\hat{ }2 or its reciprocal value, where f is the focal length of the object point, λ is the wavelength of the light, and p is a constant which is preferably defined on the pixel pitch of the at least one spatial light modulation device.

54. The method as claimed in claim 51, wherein the phase value of pixels of the subhologram of the object point of the scene having equal distance from the center of the subhologram is computed using a circuit part of the at least one hologram computation circuit permanently assigned to this distance.
